(19) United States
(12) Patent Application Publication
(10) Pub. No.: US 2026/0153371 A1
(43) Pub. Date: Jun. 4, 2026

(54) CORRECTING MASS FLOW AND DENSITY MEASUREMENTS FROM CORIOLIS METERS OPERATING ON BUBBLY LIQUIDS

(71) Applicant: Corvera, LLC, South Glastonbury, CT (US)

(72) Inventor: Daniel Gysling, South Glastonbury, CT (US)

(73) Assignee: Corvera, LLC, South Glastonbury, CT (US)

(21) Appl. No.: 19/122,586

(22) PCT Filed: Apr. 7, 2023
(86) PCT No.: PCT/US2023/065511

§ 371 Date: Apr. 18, 2025

Related U.S. Application Data
(60) Provisional application No. 63/328,410, filed on Apr. 7, 2022.
(60) Provisional application No. 63/334,168, filed on Apr. 24, 2022.
(60) Provisional application No. 63/358,969, filed on Jul. 7, 2022.
(60) Provisional application No. 63/375,102, filed on Sep. 9, 2022.
(60) Provisional application No. 63/380,284, filed on Oct. 20, 2022.
(60) Provisional application No. 63/487,644, filed on Mar. 1, 2023.
(60) Provisional application No. 63/487,923, filed on Mar. 2, 2023.

(51) Int. Cl. G01F 1/84; G01N 9/32

(52) U.S. Cl. CPC G01F 1/8436; G01N 9/32

(57) ABSTRACT

In some implementations, a method is disclosed that may include operating the Coriolis meter on a process fluid where the process fluid may include a liquid continuous process fluid with particles. The method may include measuring a measured speed of sound of the process fluid, deriving a first correlation input parameter from the measured speed of sound the process fluid, determining at least one correlation output parameter utilizing an optimized Coriolis correction correlation between the correlation output parameter and the first correlation input parameter and at least a second correlation input parameter. Also, the method may include where the optimized Coriolis correction correlation is determined utilizing a training data set which relates the correlation input parameters to the correlation output parameters at a plurality of operating conditions and correcting the at least one measured Coriolis output parameter utilizing the at least one correlation output parameter.

### CROSS-REFERENCE TO RELATED APPLICATION

This patent application claims priority to U.S. Provisional Patent Application No. 63/328,410, filed on 7 Apr. 2022, and entitled “Method to Correct Coriolis Meters for Effects of Decoupling” and to U.S. Provisional Patent Application No. 63/334,168, filed on 24 Apr. 2022, and entitled “Method to Determine Characteristics of a Bubbly Mixture Using a Coriolis Meter Utilizing a Measure of the Drive Gain”, and to U.S. Provisional Patent Application No. 63/358,969, filed on 7 Jul. 2022, and entitled “Optimization of Correlation between Mass Flow Decoupling Error and Density Decoupling Error”, and to U.S. Provisional Patent Application No. 63/375,102, filed on 9 Sep. 2022, and entitled “ACCURATE MASS FLOW AND DENSITY OF BUBBLY FLUIDS USING A SPEED OF SOUND AUGMENTED CORIOLIS FLOW METER”, and to U.S. Provisional Patent Application No. 63/380,284, filed on 20 Oct. 2022, and entitled “USE OF VIBRATIONAL AMPLITUDE AS A QUALITY INDICATOR TO SPEED OF SOUND AUGMENTED CORIOLIS METERS”, and to U.S. Provisional Patent Application No. 63/487,644, filed on 1 Mar. 2023, and entitled “CORRECTING MASS FLOW MEASUREMENTS FOR CORIOLIS METERS OPERATING ON BUBBLY LIQUIDS”, as well as U.S. Provisional Patent Application No. 63/487,923, filed on 2 Mar. 2023, and entitled “DETERMINING LIQUID DENSITY USING CORRELATION FOR DENSITY ERROR PARAMETERS BASED ON MEASURED PARAMETERS”. The disclosure of the prior applications are considered part of and are incorporated by reference into this patent application.

### BACKGROUND OF THE DISCLOSURE

### Field of the Disclosure

The present disclosure relates to flow measurement devices.

### Description of the Related Art

Coriolis meters as defined herein are flow measurement devices that measure the mass flow and/or density of a process fluid being conveyed through one or more vibrating flow tubes based on interpreting the effect of said process fluid on the vibrational characteristics of said flow tubes.

Coriolis meters are typically calibrated for use on single phase fluids. When operating on bubbly liquids, the presence of the bubbles modifies the interactions of the vibrating flow tubes and the fluid conveyed within the flow tubes, resulting in errors in the mass flow and density reported by Coriolis meters operating on bubbly liquids.

Errors developed in the mass flow and density of Coriolis meters operating on bubbly liquids are in general a complex function of many parameters, including the design characteristic of the Coriolis meter and the characteristics of the process fluid including fluid viscosity, gas void fraction, bubble size and distribution, and many more parameters. It is noted that Coriolis meters provide mass flow and density measurements based on interpretation of the vibrational characteristics of fluid-conveying flow tubes. Coriolis meters can also provide volumetric flow measurement; however, volumetric flow is not measured directly, but rather is a quantity determined by dividing the measured process fluid mass flow by the measured process fluid density. Thus, correcting for errors in the mass flow and/or the density is directly linked to correcting errors in the volumetric flow as well.

Although Coriolis manufacturers have developed software algorithms and best practices designed to mitigate errors due to bubbly flows, there currently is no commercially available methodology designed to maintain near single-phase accuracy on bubbly liquids.

There have been several approaches proposed to correct for errors in Coriolis meters operating on bubbly flows. Approaches to correct for errors in Coriolis meters operating on bubbly liquids have leveraged at least two types of approaches. The first approach utilizes physics-based, reduced-order, analytical models for the effects of entrained gases on Coriolis meters. Examples of these models include models by Hemp, Zhu, and Gysling. These models utilize reduced-order, analytical models, and often use parameters within the analytical models which are often identified experimentally, to predict the effect of entrained gases on Coriolis meters. While typically successful in predicting trends, these models typically lack the fidelity to provide quantitatively accurate corrections. Examples of this approach to correct the output of Coriolis meters for the effects of entrained gases are given in the work of Zhu, in which he utilizes a “Two Mode Compensation” approach and “Coriolis Mass Flow Damping Compensation” approach. As indicated by Zhu, his error compensation methods rely on “inputting” or estimating parameters within his reduced-order analytical models, such as Zhu's K_{bub} decouple parameter, the Kᵣₑₛ constant relating errors due to compressibility on the mass flow measurement to errors due to compressibility of density measurement, as well as other empirically determined input parameters.

Currently there are no practical physics-based reduced-order analytical models that are known to predict errors developed in Coriolis meters due to bubbly liquids from a first-principles basis that can sufficiently mitigate the errors such that the Coriolis meter can maintain near single phase accuracy on bubbly liquids. It may be possible to utilize computational methods such as computation fluid dynamics and computational structural dynamics to accurately predict the impact of entrained particles on Coriolis meters, however, these techniques remain too computational expense to be utilized in most practical applications.

A second known approach utilized to correct errors in Coriolis meters due to entrained particles utilizes correlation models developed to correlate the errors in Coriolis meters to measurable, or known, or calculatable correlation input parameters. For example, Artificial Neural Networks have been applied to Coriolis meters in an effort to improve accuracy under multiphase flow conditions. These Artificial Neural Networks are correlations developed from training data sets which relate errors in Coriolis meters operating on multiphase flows to measured and known correlation input parameters. Artificial Neural Networks can be very effective at mitigating errors for situations in which the training data set is highly representative of conditions over which the compensation is applied. Conversely, since these models are often not strongly-grounded in physics, these Artificial Neural Networks can produce highly inaccurate predictions if mis-applied. Ibryaeva provides an overview of Artificial Neural Networks applied to Coriolis meters operating on multiphase fluids. It is noted that Ibryaeva does not teach the use of any of the process fluid speed, an excitation energy parameter, or a vibration amplitude parameters as either parameters included within in the training set, nor as an correlation input parameters. Ibryaeva does include a reference gas volume fraction measurement in the training set, but does not teach the use of a gas void fraction being used as a correlation input parameter. L. Wang teaches the use of neural networks to correct the mass flow of Coriolis meters operating on two phase flows in which the following are used as correlation input parameters, 1) Coriolis damping term, derived from the ratio of the excitation energy to the vibration amplitude 2) a density drop term, and 3) the measured Coriolis mass flow, but Wang does not teach the use of a process fluid sound speed measurement as a correlation input parameter.

Gysling, in U.S. Pat. No. 7,152,460, teaches the use a process fluid sound speed measurement to correct Coriolis mass flow and density measurements operating on bubbly flows. Gysling provides a reduced order analytical model which predicts errors in the mass flow and density measured by a Coriolis meter operating on a bubbly liquid, however, Gysling does not teach any method with which to apply the model, or any other model, to correct the output of a Coriolis meter operating on bubbly liquids.

Other prior art methods have proposed the use of correlations and have provided data sets which include Coriolis measurement errors and reference gas void fractions.

It is important to note that training data sets which include a reference gas void fraction are functionally different from training data sets developed utilizing process fluid sound speed measurement measured across the flow tubes of a Coriolis meter.

What is needed is a robust, practical method to correct for errors in mass flow and density measured by Coriolis meters operating on bubbly liquids. Ideally, such methods would enable Coriolis meters to maintain near single phase accuracy when operating on bubbly liquids.

### SUMMARY OF THE DISCLOSURE

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include operating the Coriolis meter on a process fluid where the process fluid may include a liquid continuous process fluid with particles. The method may also include measuring a measured speed of sound of the process fluid. The method may furthermore include deriving a first correlation input parameter from the measured speed of sound the process fluid. The method may in addition include determining at least one correlation output parameter utilizing an optimized Coriolis correction correlation between the correlation output parameter and the first correlation input parameter and at least a second correlation input parameter, where the at least second correlation input parameter may include of any of a process fluid parameter indicative of at least one of operating condition of the process fluid within the Coriolis meter a Coriolis operating parameter indicative of the Coriolis meter operating on the process fluid and a Coriolis error parameter of the Coriolis meter. The method may moreover include where the correlation is determined utilizing a training data set which relates the correlation input parameters to the correlation output parameters at a plurality of operating conditions. The method may also include correcting the at least one measured Coriolis output parameter utilizing the at least one correlation output parameter. Other embodiments of this aspect include corresponding computer systems, apparatus, and computer programs recorded on one or more computer storage devices, each configured to perform the actions of the methods.

Implementations may include one or more of the following features. The method where the correlation is further determined by optimizing a plurality of correlation weighting parameters configured to minimize a difference between a predicted correlation output parameter and a correlation output parameter contained within or derived from the training data set. The method where the at least a second correlation input parameter is derived from any of an excitation energy metric and a vibrational amplitude metric. The method where the at least at least a second correlation input parameter may include any of a mass flow, a density and a volumetric flow of the Coriolis meter. The method where the particles may include gas bubbles. The method where the at least a second correlation input parameter may include any of a speed of sound, a gas void fraction of the process fluid. The method where the at least a second correlation input parameter is a density error parameter. The method may include utilizing an array of acoustic pressure transducers that spans at least one flow tube of the Coriolis meter. The method where the optimized Coriolis correction correlation may include a neural network. The method where the optimized Coriolis correction correlation may include a least squares correlation. Implementations of the described techniques may include hardware, a method or process, or a computer tangible medium.

In one general aspect, a system may include one or more processors configured to operate the Coriolis meter on a process fluid where the process fluid may include a liquid continuous process fluid with particles measure a measured speed of sound of the process fluid derive a first correlation input parameter from the measured speed of sound the process fluid determine at least one correlation output parameter utilizing an optimized Coriolis correction correlation between the correlation output parameter and the first correlation input parameter and at least a second correlation input parameter, where the at least second correlation input parameter may include of any of a process fluid parameter indicative of at least one of operate condition of the process fluid within the Coriolis meter a Coriolis operate parameter indicative of the Coriolis meter operating on the process fluid and a Coriolis error parameter of the Coriolis meter. The system may also include where the correlation is determined utilize a training data set which relates the correlation input parameters to the correlation output parameters at a plurality of operating conditions. The system may furthermore include correct the at least one measured Coriolis output parameter utilizing the at least one correlation output parameter. Other embodiments of this aspect include corresponding computer systems, apparatus, and computer programs recorded on one or more computer storage devices, each configured to perform the actions of the methods.

Implementations may include one or more of the following features. The system where the correlation is further determined by optimizing a plurality of correlation weighting parameters configured to minimize a difference between a predicted correlation output parameter and a correlation output parameter contained within or derived from the training data set. The system where the at least a second correlation input parameter is derived from any of an excitation energy metric and a vibrational amplitude metric. The system where the at least at least a second correlation input parameter may include any of a mass flow, a density and a volumetric flow of the Coriolis meter. The system where the particles may include gas bubbles. The system where the at least a second correlation input parameter may include any of a speed of sound, a gas void fraction of the process fluid. The system where the at least a second correlation input parameter is a density error parameter. The system may include utilizing an array of acoustic pressure transducers that spans at least one flow tube of the Coriolis meter. The system where the optimized Coriolis correction correlation may include a neural network. The system where the optimized Coriolis correction correlation may include a least squares correlation. Implementations of the described techniques may include hardware, a method or process, or a computer tangible medium.

In one general aspect, a Coriolis meter may include one or more processors configured to operate the Coriolis meter on a process fluid where the process fluid may include a liquid continuous process fluid with particles measure a measured speed of sound of the process fluid derive a first correlation input parameter from the measured speed of sound the process fluid determine at least one correlation output parameter utilizing an optimized Coriolis correction correlation between the correlation output parameter and the first correlation input parameter and at least a second correlation input parameter, where the at least second correlation input parameter may include of any of a process fluid parameter indicative of at least one of operate condition of the process fluid within the Coriolis meter a Coriolis operate parameter indicative of the Coriolis meter operating on the process fluid and a Coriolis error parameter of the Coriolis meter. The Coriolis meter may also include where the correlation is determined utilize a training data set which relates the correlation input parameters to the correlation output parameters at a plurality of operating conditions. Meter may furthermore include correct at least one measured Coriolis output parameter utilizing the at least one correlation output parameter. Other embodiments of this aspect include corresponding computer systems, apparatus, and computer programs recorded on one or more computer storage devices, each configured to perform the actions of the methods.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a graphical representation of a mass flow error parameter (Phi) and a density error parameter (Psi) for a Coriolis meter in accordance with the present disclosure;

FIG. 2 is a graphical representation of a mass flow error parameter (Phi) and a density error parameter (Psi) for a Coriolis meter in accordance with the present disclosure;

FIG. 3 is a graphical representation of a decoupling ratio of a gas bubble with a liquid as a function of inverse stokes number from the prior art;

FIG. 4 is a graphical representation of a measured speed of sound for a Coriolis meter as a function of gas void fraction over a range of operating conditions for a training data set in accordance with the present disclosure;

FIG. 5 is a graphical representation of the reduced frequency squared for two Coriolis meters as a function of gas void fraction over a range of operating conditions for a training data set in accordance with the present disclosure;

FIG. 6 is a graphical representation for two Coriolis meters as a function of gas void fraction over a range of operating conditions for a training data set in accordance with the present disclosure;

FIG. 7 is a graphical representation of the measured vibration amplitude for two Coriolis meters as a function of gas void fraction over a range of operating conditions for a training data set in accordance with the present disclosure;

FIG. 8 is a graphical representation of the measured excitation energy to the measured vibration amplitude for two Coriolis meters as a function of gas void fraction over a range of operating conditions for a training data set in accordance with the present disclosure;

FIG. 9 is a graphical representation of measured (raw) density and the corrected liquid density for two Coriolis meters using a least squares optimization of parameters for the effective of gas void fraction, reduced frequency squared, and the ratio of excitation energy to vibration amplitude on the density error parameter as a function of gas void fraction in accordance with the present disclosure;

FIG. 10 is a graphical representation of measured (raw) density and the corrected liquid density for two Coriolis meters using a least squares optimization of parameters for the effective of gas void fraction, reduced frequency squared, and the ratio of excitation energy to vibration amplitude on the density error parameter as a function of gas void fraction in accordance with the present disclosure;

FIG. 11 is a schematic of an implementation of a neural network used to determine a density error function from 4 input parameters using a 1 hidden layer with 3 neurons and an output layer with a 1 neuron in accordance with the present disclosure;

FIG. 12 is a graphical representation of measured (raw) density and the corrected liquid density for Coriolis meter a and b using a neural net which uses the gas void fraction, reduced frequency squared, and excitation energy and the vibration amplitude as inputs as function of gas void fraction in accordance with the present disclosure;

FIG. 13 is a graphical representation of measured (raw) density and the corrected liquid density for Coriolis meter a and b using a neural net which uses the gas void fraction, reduced frequency squared, and excitation energy and the vibration amplitude as inputs as function of gas void fraction in accordance with the present disclosure;

FIG. 14 is a graphical representation of measured (raw) density and the corrected liquid density for a Coriolis meter using a neural net using the reduced pressure and the ratio of excitation energy to vibration amplitude on the density error parameter as a function of gas void fraction in accordance with the present disclosure;

FIG. 15 is a graphical representation of a neural network utilizing two inputs, gas void fraction and reduced frequency squared, with one hidden layer with 3 neurons, and a single neuron output layer for a Coriolis meter in accordance with the present disclosure;

FIG. 16 is a schematic of an implementation to utilize measured values and an optimized Coriolis correction correlation to determine a corrected liquid density in accordance with the present disclosure;

FIG. 17 is a graphical representation of the raw and corrected mass flow for a Coriolis meter utilizing a least squares optimization in accordance with the present disclosure;

FIG. 18 is a graphical representation of the raw and corrected mass flow for a Coriolis meter utilizing methodology described utilizing a least squares optimization measurement in accordance with the present disclosure;

FIG. 19: is a schematic of an implementation of a neural network used to correct the mass flow of a Coriolis meter in accordance with the present disclosure;

FIG. 20 is a graphical representation of the raw and corrected mass flow for a Coriolis meter using a neural network in accordance with the present disclosure;

FIG. 21 is a graphical representation of the raw and corrected mass flow for a Coriolis meter using a neural network in accordance with the present disclosure;

FIG. 22 is a graphical representation of the raw and corrected mass flow for a Coriolis meter using a neural network with the density error parameter, the excitation energy and the vibration amplitude as inputs in accordance with the present disclosure;

FIG. 23 is a graphical representation of the raw and corrected mass flow for a Coriolis meter using a neural network with the gas void fraction, the reduced frequency squared, the excitation energy and the vibration amplitude as inputs in accordance with the present disclosure;

FIG. 24 is a graphical representation of the raw and corrected mass flow for a Coriolis meter using a neural network with the gas void fraction and reduced frequency squared as inputs in accordance with the present disclosure;

FIG. 25 is a schematic of an implementation which utilizes the density error parameter, the gas void fraction, the reduced frequency squared, the excitation energy, and 1—the vibration amplitude as inputs in accordance with the present disclosure;

FIG. 26 is a side view in partial section of a Coriolis meter in accordance with the present disclosure;

FIG. 27 is a cross section view of a Coriolis meter in accordance with the present disclosure; and

FIG. 28 is a flow chart of a correction method for a Coriolis meter in accordance with the present disclosure.

### DETAILED DESCRIPTION

In the following detailed description of the embodiments, reference is made to the accompanying drawings, which form a part hereof, and within which are shown by way of illustration specific embodiments by which the examples described herein may be practiced. It is to be understood that other embodiments may be utilized and structural changes may be made without departing from the scope of the disclosure.

The methods disclosed herein provide a framework for leveraging training data sets which span a relevant range of non-dimensional operating conditions for a given Coriolis meter design, to develop optimized Coriolis correction correlations based on measured process fluid parameters and/or measured Coriolis operating parameters and/or Coriolis error parameters to provide a means to correct for errors in the mass flow, density, or volumetric flow reported by Coriolis meters, where the Coriolis meter is calibrated for operation on single phase fluids but are operating on liquids with entrained particles. Note that the term “entrained particles” includes a wide variety of flow inhomogeneities including gas bubbles. This methodology can be viewed as an empirically-informed, first-principles-motivated model to correct for errors in Coriolis meters operating on bubbly liquids. The mass flow, density, and volumetric flow reported by a Coriolis meter are referred to in this disclosure as the “measured Coriolis output parameters”. Note that the term “mass flow” used in this disclosure is synonymous with the term “mass flow rate” and is used to specify the mass flow rate of a process fluid, typically in units of mass per unit time.

It is known by those skilled in the art that the accuracy of a Coriolis meter is adversely affected if the process fluid contains particles, where term particles includes solid particles and/or gas bubbles. This disclosure primarily provides examples and analysis Coriolis meters operating on bubbly flows, however, as would be understood by those skilled in the art, bubbly liquids can be considered a subset of liquids with entrained particles.

As part of the present disclosure, a group of parameters are defined as “correlation input parameters”. Correlation input parameters are used as inputs to the optimized Coriolis correction correlations developed to correct Coriolis meters using methods disclosed herein. Correlation input parameters are composed of three sub-groups defined as the following 1) process fluid parameters; 2) Coriolis operating parameters; and 3) Coriolis error parameters. Collectively, these three sub-groups of parameters, and any additional parameters derived from the three sub-groups, are referred to generically as “correlation input parameters”. As used herein, collectively, mass flow error parameters, density error parameters, and volumetric flow error parameters are collectively referred to as “Coriolis error parameters”. The output parameters of a correlation, which typically include Coriolis error parameters, are collectively referred to as “correlation output parameters”. Corrected values for the mass flow, density, or volumetric flow, determined using a “measured Coriolis output parameter” and a “Coriolis error parameter” are referred to in this disclosure as the “corrected Coriolis output parameters”.

This disclosure is novel and represents an improvement in the state of the art for many reasons. These reasons included in the current disclosure utilizing a training data with which to develop optimized Coriolis correction correlations to correct measured output of Coriolis meter which include Coriolis flow measurement errors and a process fluid sound speed measurement measured within the flow tubes of the Coriolis meter. Furthermore, this is the first application of an optimized Coriolis correction correlation developed from a training data set to correct Coriolis meters which utilizes a process fluid sound speed, and parameters derived from this process fluid sound speed measurement, as input correlation parameters to optimized Coriolis correction correlations developed to correct for flow measurement errors due to process fluids with entrained particles.

It should be further understood that parameters used in an optimized Coriolis correction correlation which defines relationships among the correlation input parameters and the correlation output parameters are referred to as “correlation weighting parameters”.

As used herein, “process fluid parameters” are defined as any parameter of the process fluid that is either known or measured, or determined based on known or measured values, that is associated with the process fluid such as the process pressure, temperature, and sound speed (either sub or super bubble resonant), gas void fraction, bubble size (if available), liquid viscosity, as well as parameters from the process fluid that can be estimated or inferred based on the output of the Coriolis meter operating in a liquid continuous flow with particles, such as mixture flow velocity, mass flow, and density.

Further, as used herein “Coriolis operating parameters” are defined as any parameter of the Coriolis meter operation on the process fluid that is either known or measured, and which may involve the use of a process fluid parameter in its determination, such as tube vibrational frequency, measured mass flow, density, or volumetric flow, reduced frequency, reduced pressure, excitation energy metric, vibration energy metric, inverse Stokes number, etc.

It should be further understood that “Coriolis error parameter” is defined as any parameter that is indicative of errors in any of the following: the mass flow, density, or volumetric flow reported by a Coriolis meter, which was calibrated to report accurate values on single phase fluids but operating on liquid continuous flows with particles.

Correlations developed among correlation input parameters (including “process fluid parameters” and “Coriolis operating parameters” and “Coriolis error parameters”) and correlation output parameters (typically Coriolis error parameters) are, in general, intended to be applicable to bubbles mixtures whose non-dimensional parameters are spanned by the range of non-dimensional parameters of the training data set. For example, a training data set would ideally span the range of non-dimensional parameters which govern the effect of entrained particles on the mass flow and density of reported by Coriolis meters. These non-dimensional parameters include, for example, inverse Stokes numbers, reduced frequencies, reduced pressures, and gas void fractions, particle-to-liquid density ratios, in the Weinstein and Basse reference of the intended operating range over which the correlation will be used. It is important to note that there is no explicit need to match the dimensional characteristics of the fluids, such as, for example, liquid viscosity, bubble size, density, used to develop the training data set and the intended operating fluids. The methods disclosed herein enable a training data set to be developed on, for example, air and water, and to be subsequently applied to an oil and natural gas application. It is also noted, that while preferred, there is no explicit need for the training data set to span the range of input process fluid parameters and Coriolis operating parameters to utilize the methodologies described in this disclosure.

As defined herein, and as known to those skilled in the art, developing an optimized Coriolis correction correlation (OCCC) between input correlation parameters and output correlation parameters involves optimizing the correlation weighting parameters to minimize an error function. The error function can be viewed as a quantity that is indicative of difference between 1) trial correlation output parameter(s) generated by applying the Coriolis correction correlation with trial correlation weighting parameters to input correlation parameters associated each data point in the training data set, and 2) the same output parameter(s) associated with each data point in the training data set. For example, the sum of the square of the differences between a predicted correlation output parameter and the actual output parameter, evaluated at each data point in the training set and summed over all the points in the training data set, would be a suitable error function. In an optimization process, the trial values of the correlation weighting parameters are optimized to minimize an error function. Methods to optimize a correlation include analytically, for example in linear regression, or iteratively, i.e. in most methods used to train a neural network.

Methods are presented as part of the present disclosure to quantify and mitigate measurement errors that develop in prior art Coriolis meters operating on liquid continuous flows with particles in general and on bubbly liquids specifically. As part of the present disclosure and as defined herein, a mass flow error parameter, Φ has been discovered and is defined as:

$$Φ ≡ 1 - \frac{{\dot{m}}_{meas}}{{\dot{m}}_{liq}} \qquad ( Equation 1 )$$

Where \dot{m}_{liq} is the mass flow of the liquid and \dot{m}ₘₑₐₛ is the mass flow reported by a Coriolis meter operating on a bubbly mixture, but calibrated on a single phase, essentially homogeneous liquid with a small reduced-frequency, f_{red}<<1, where the reduced-frequency is defined as:

$${f}_{red} ≡ \frac{2 π {f}_{tube} ( \frac{{D}_{tube}}{2} )}{{a}_{mix}} \qquad ( Equation 2 )$$

Where f_{tube} is the vibrational frequency of the tube, D_{tube} is the diameter of the tube, and aₘᵢₓ is the speed of sound of the process fluid.

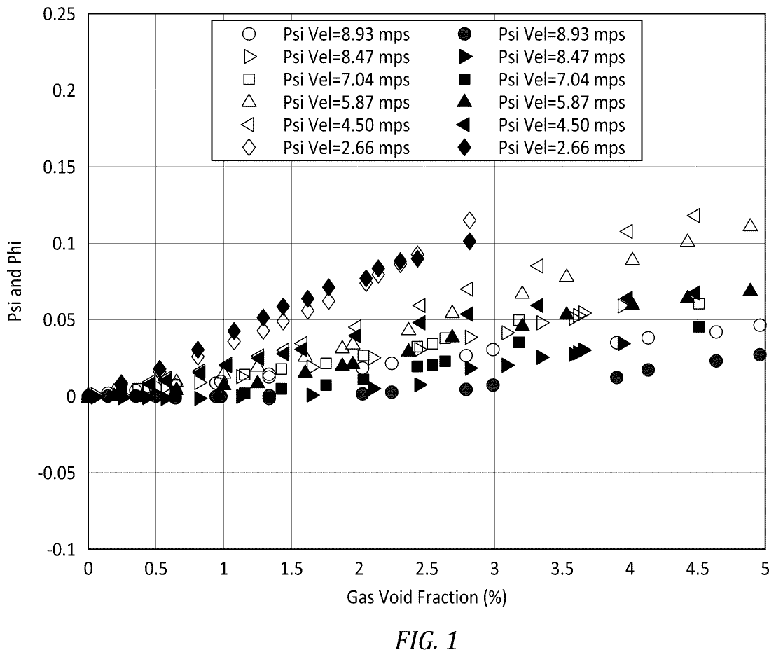

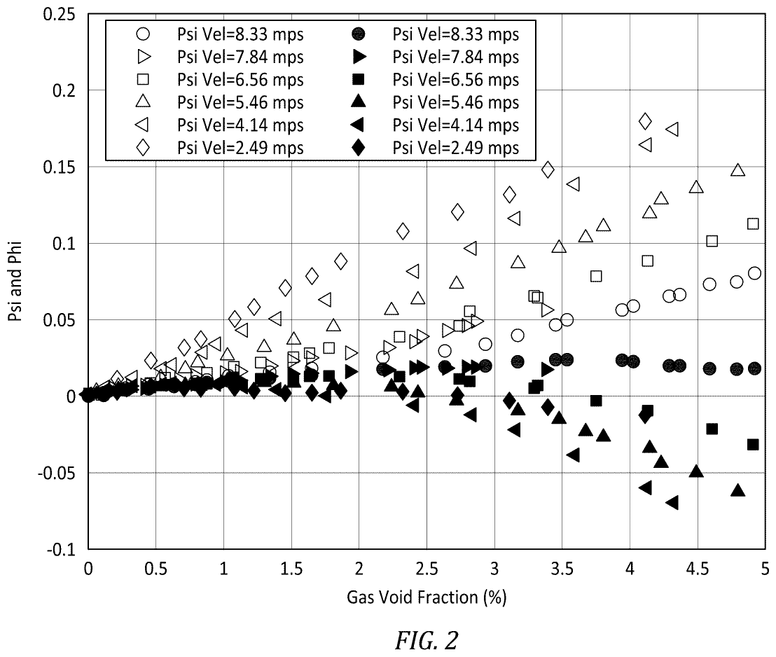

Thus, knowing the measured mass flow, \dot{m}ₘₑₐₛ, and having an estimate for the mass flow error parameter, Φ, provides a measure of the liquid mass flow, \dot{m}_{liq}. Similarly, a density error parameter has been discovered as part of the present disclosure, Ψ, is defined as:

$$Ψ ≡ 1 - \frac{{ρ}_{meas}}{{ρ}_{liq}} \qquad ( Equation 3 )$$

Where ρ_{liq} is the density of the liquid and ρₘₑₐₛ is the density reported by a Coriolis meter operating on a bubbly mixture but calibrated on a single phase, essentially homogeneous liquid with a small reduced frequency, f_{red}<<1, the reduced frequency. It is noted that, the intent of a Coriolis error parameter is to provide a measurement of the error in a measured Coriolis output parameter. As such, the specific definition of Coriolis error parameters can be varied with departing from implementations of the current disclosure. Referring to FIGS. 1, 2 there is shown the mass flow error parameter, Φ, and the density error parameter, Ψ, for two, modern, 2-inch, dual bent-tube Coriolis meters of the prior art operating on bubbly mixtures of air and water over a range of mixture velocities and gas void fractions. Data was recorded in data sets for which the nominal mixture flow velocity and pressure within the Coriolis meter was held nominally constant, and the gas void fraction was increased from 0% to 5%. It should be noted that although the maximum gas void fraction is shown as 5%, this maximum limit is a result of the specific experimental set up used to generate the data and not any limitation of the general principles of the current disclosure. As such, implementations of the present disclosure are not limited to the experimentally demonstrated limitations and extend well beyond those shown in the graphical representations. The legends indicate the nominal mixture velocities of the bubbly mixtures within the flow tubes for each data set. The data shown in FIGS. 1 and 2, along with other data and data presented in other figures constitute two training data sets, one for Coriolis meter A and one for Coriolis meter B. The nominal operating conditions for each data set shown in FIG. 1 are given in the following table:

TABLE 1

| Coriolis Meter A | | | Coriolis Meter B | | |
|---|---|---|---|---|---|
| ID = 1.06 in/f_{tube} = 80 Hz | | | ID = 1.10 in/f_{tube} = 175 Hz | | |
| Vel Nom | Pressure | Reduced | Vel Nom | Pressure | Reduced |
| (m/s) | (psia) | Pressure | (m/s) | (psia) | Pressure |
| 8.93 | 25.0 | 3.49 | 8.33 | 23.8 | 0.75 |
| 8.47 | 30.0 | 4.20 | 7.84 | 30.4 | 0.96 |
| 7.04 | 23.8 | 3.33 | 6.56 | 23.5 | 0.74 |
| 5.87 | 30.9 | 4.33 | 5.46 | 30.8 | 0.97 |
| 4.50 | 37.3 | 5.23 | 4.14 | 37.6 | 1.18 |
| 2.66 | 43.0 | 6.03 | 2.49 | 43.2 | 1.36 |

As indicated in the table, natural frequency of the flow tubes of Coriolis meter A was approximately 80 Hz when filled with water, and the natural frequency of the flow tubes of Coriolis Mater B was approximately 175 Hz when filled with water. The reduced frequency, defined below for each nominal operating condition is also listed.

As shown, the mass flow error parameter, Φ, and the density error parameter, Ψ, in general, tend to increase with gas void fraction. The gas void fractions shown in the figures were determined based on a measurement of the sub-bubble-resonant speed of sound of the process fluid within the flow tubes of the Coriolis meter utilizing an array of acoustic pressure transducers which spanned the flow tubes and Wood's equations, assuming an isothermal polytropic index (γ=1.0).

As indicated by the mass flow error parameter, Φ, the mass flow measured by the Coriolis meters differs from the actual mass flow of the liquid. And, as indicated by the density error parameter, Ψ, the density measured by the Coriolis meters differs from that of the actual liquid phase of the bubbly liquid. The difference is shown to be a function of gas void fractions and are dependent on the different operating conditions of the bubbly fluid.

It will be known by those skilled in the art that several authors have developed reduced-order, physics-based models for the errors developed in Coriolis meters operating on bubbly liquids in the prior art. For example, Hemp, 2006, presented a model for the errors developed in Coriolis meters operating on bubbly liquids that provides a concise, first-principles formulation for the errors associated with both decoupling and compressibility. Hemp's model predicts that the density measured by a Coriolis meter, calibrated on an essentially homogeneous and incompressible single-phase flow, but operating on a bubbly liquid, is related to the density of the liquid phase as follows:

$${ρ}_{meas} = {ρ}_{liq} ( 1 - {K}_{d} α + {G}_{d} {f}_{red}^{2} ) \qquad ( Equation 4 )$$

Where ρₘₑₐₛ is the measured density, ρ_{liq} is the density of the liquid phase, a is gas void fraction, f_{red} is the reduced frequency, defined below:

$${f}_{red} ≡ \frac{2 π {f}_{tube} D / 2}{{a}_{mix}} \qquad ( Equation 5 )$$

Where f_{tube} is the vibrational frequency of the tube, D is the inner diameter of the tube, and aₘᵢₓ is the sound speed of the process fluid. The reduced frequency is a non-dimensional number that characterizes the impact of fluid compressibility on Coriolis flow meters. K_{d} is the density decoupling parameter which quantifies the effect of decoupling on the density measured by a Coriolis meter operating on bubbly flow. K_{d} theoretically spans from unity for fully-coupled flows to three for fully-decoupled conditions (1<K_{d}<3).

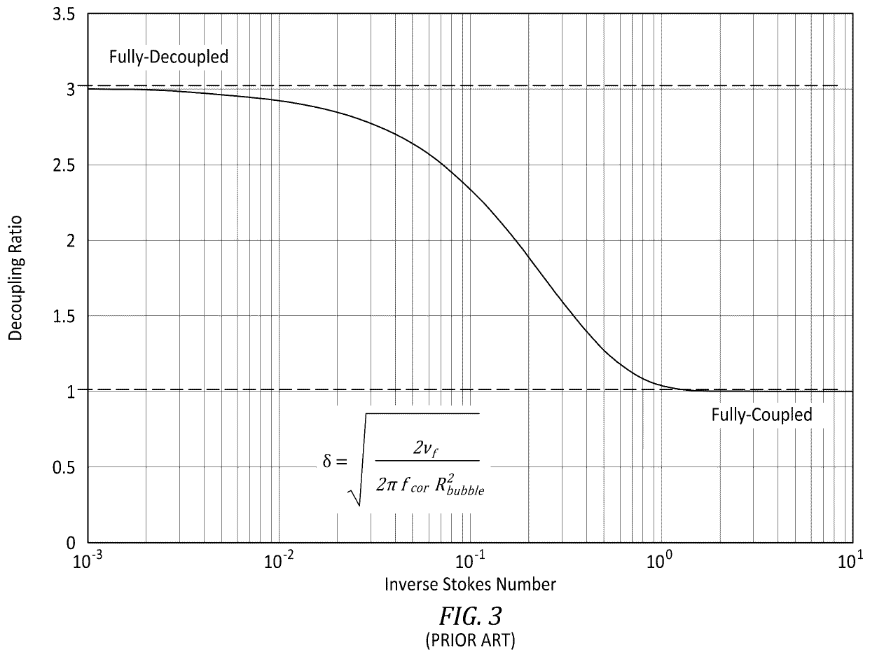

The density decoupling parameter is theoretically linked to the decoupling ratio, defined as the ratio of vibrational amplitude of gas bubbles compared to that of the flow tubes, and to first order, the liquid, in the transverse oscillations of the fluid-conveying flow tubes. Bubbly liquids are said to “decouple” when the vibrational amplitude of the bubbles departs from that of the liquid. Referring to FIG. 3, there is shown a graphical representation from the prior art of an approximation of the decoupling ratio of bubbly liquids as a function of inverse Stokes number. The inverse Stokes number is defined as follows:

$$δ ≡ \sqrt{\frac{2 μ}{{ρ}_{liq} 2 π {f}_{tube} {R}_{bubble}^{2}}} \qquad ( Equation 6 )$$

Where μ is the dynamic viscosity of the liquid phase, ρ_{liq} is the density of the liquid, and R_{bubble} is a representative bubble radius. The smaller the inverse Stokes number, (i.e., less viscous fluids, larger sized bubbles, higher vibrational frequency), the more decoupling that occurs. Theoretically, the maximum decoupling occurs at the inviscid limit, associated with the inverse Stokes number approaching zero. As shown in FIG. 3, in the limit of inverse Stokes number approaching zero, the decoupling ratio approaches three (K_{d} [symbol] 3). For large inverse Strokes numbers, the bubbles become ‘fully-coupled’ to the liquid phase and the effects of decoupling are eliminated and K_{d} approaches unity (K_{d} [symbol] 1).

In Hemp's formulation of the prior art, the effect of compressibility is captured by the product of G_{d}, the density compressibility parameter, and the square of the reduced frequency,

$${f}_{red}^{2} .$$

Hemp suggests a value of G_{d}=0.25 for the density compressibility parameter. For positive values of K_{d} and G_{d}, the effects of decoupling and compressibility generate offsetting errors in the measured density of bubbly flows, with decoupling effects causing under-reporting of liquid density and compressibility effects causing an over-reporting of liquid density.

Similarly, Hemp's model predicts that the mass flow measured by a Coriolis meter operating on a bubbly liquid is related to the mass flow of the liquid as follows:

$${\dot{m}}_{meas} = {\dot{m}}_{liq} ( 1 - \frac{( {K}_{m} - 1 )}{1 - α} α + {G}_{m} {f}_{red}^{2} ) \qquad ( Equation 7 )$$

Where Kₘ is the mass flow decoupling parameter (1<Kₘ<3) and Gₘ is the mass flow compressibility parameter. Hemp suggests a value for the mass flow compressibility parameter of Gₘ=0.5. Theoretical models Hemp [4] and Zhu [8], predict that the density and mass flow decoupling parameters should be equal (K_{d}=Kₘ) and that compressibility has a 2× or greater effect on mass flow compared to density (Gₘ≥2G_{d}).

Hemp's model, and models similar to Hemp's model, are reduced-order, physics-based, analytical models. These models provide insight into the error mechanisms associated with Coriolis meters operating on bubbly liquids. For example, Hemp's model predicts that errors due to decoupling will scale with the inverse Stokes number and the gas void fraction, and errors due to compressibility should scale with the square of the reduced frequency. However, these models, in general, are unable to predict the errors in mass flow and density with sufficient accuracies to be used to quantitatively correct the measured mass flow and density of Coriolis meters operating over a range of conditions. These limitations are likely results of simplifications in the analysis, for example flow tube geometry simplifications, and lack of knowledge of input parameters, such as bubble size need to determine the inverse Stokes number, as well as other, potentially unmodelled effects.

It should be appreciated by those skilled in the art that decoupling parameters, such as K_{d} and Kₘ, are reflective of the ratio of the amplitude of vibration of the particle, or bubble, to amplitude of the vibration of the continuous phase (for bubbly flows, the liquid phase) in an inhomogeneous fluid undergoing transverse vibration. As indicated in FIG. 3, the decoupling ratio for a given set of conditions is a function inverse Stokes number which is function of liquid viscosity, Coriolis vibrational frequency, and bubble size.

In addition to inaccuracies of the models, the reduced order models often contain unknown, and often unknowable parameters. For example, although conceptually useful, it is difficult to determine the inverse Stokes number on a real time basis. While liquid viscosity and tube vibrational frequency can generally be estimated or measured with commonly available knowledge or instruments, bubble size, is typically unknown, often highly variable. Bubble size within a bubbly liquid can depend on many factors, including flow velocity and surface tension effects and other factors. Bubble size is typically set by equilibrium conditions among mechanisms which serve to break-up larger bubbles into smaller bubbles, such as turbulence, and mechanisms which lead to larger bubbles, such as bubble coalescence, and pressure reduction. Although bubble size is an important parameter governing the behavior of bubbly fluid within Coriolis meters, and is useful from a mechanistic understanding, given the complexity of bubbly liquids, it is generally not practical to either accurately predict or measure bubble size of bubbly liquids on a real time basis. It is important to note that the methodologies presented in this disclosure do not require any direct measurement of, or knowledge of, bubble size.

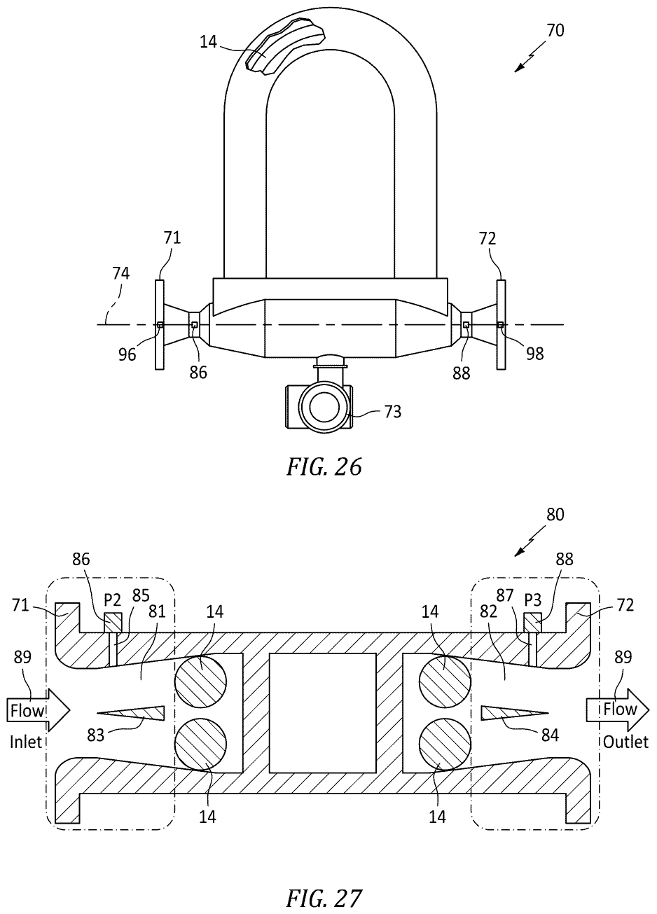

Inventive methods that develop optimized Coriolis correction correlations among errors in the measured mass flow and/or density and the other measured parameters to provide an improved measurement of the mass flow and/or density of the liquid phase of bubbly liquids are set forth in this disclosure. Embodiments of these inventive methods may use a process fluid sound speed measurement as a measured process fluid parameter that is utilized in the developing of optimized Coriolis correction correlations based on a training data set to reduce the errors in the mass flow and/or density of bubbly fluids. An example of an apparatus to measure the process fluid sound speed in the flow tubes of a Coriolis meter are disclosed herein below with reference to FIGS. 26, 27. The measured process fluid sound speed is utilized along with other commonly measured or known or estimated fluid process parameters and Coriolis operating parameters, to determine the gas void fraction and/or reduced frequency. These other commonly measured or known or estimated fluid process parameters and Coriolis operating parameters may include the process pressure and temperature of the process fluid and the vibrational frequency of the flow tubes, as well as other information about the process fluid such as the sound speed and densities of the gas and liquid phases.

It is important to note that implementations of the current disclosure utilize a measured speed of sound of the process fluid within the flow tubes (14, FIG. 26) of the Coriolis meter to calculate a gas void fraction of the process fluid within the Coriolis meter. This measurement of gas void fraction is distinct from other methods typically utilized to estimate gas void fractions in Coriolis meters operating on bubbly liquids. For example, data sets recorded for Coriolis meters operating on bubbly flows typical utilize gas void fraction measurements based on gas volume fractions calculated based on measurement measurements of the single phase liquid and single phase gas made prior to an injection point, where the gas and the liquid phases are combined to form a bubble mixture upstream of the Coriolis meter under test.

It is important to note the difference between a gas void fraction determined utilizing a process fluid sound speed measured from within the flow tubes of a Coriolis meter, and gas volume fraction determined based in conditions at an injection point. Gas volume fraction is defined herein, following established conventions for multiphase flows, as the ratio of the volume flow rate of a gas phase to the volume flow rate of the gas and liquid phases.

$$GVolF ≡ \frac{{Q}_{gas}}{{Q}_{gas} + {Q}_{liq}}$$

Gas void fraction is defined herein, also following established conventions for multiphase flows, as the volumetric fraction of gas within the mixture. Unlike gas volume fraction which can be determined by measuring the amount of gas and liquid prior to mixing, directly measuring gas void fraction is difficult with readily available instrumentation and gas void fraction is typically an interpreted parameter. For flows in which the gas phase and the liquid phases are each flowing at the same velocity, i.e. the mixture velocity, the gas void fraction is equal to the gas volume fraction. In cases where the velocity of the gas and liquid phases are different, the gas void fraction and gas volume fraction can differ. For example, vertical flow up, buoyancy forces cause bubble to rise faster than the liquid, biasing gas void fractions to be smaller than the gas volume fraction. For vertical flow downwards, the converse is true, biasing gas void fraction to be larger than the gas volume fraction. For horizontal flows, the gas tend to rises to the top of the pipe, and often flow faster than the liquid, biasing the gas void fraction to be lower than the gas volume fraction. For flows at other orientations, a complex combination of these and other effects generally occur resulting in differences between the gas void fraction and gas volume fraction, such as in a Coriolis meter. Bubble columns containing static liquid with gas injected at the bottom and rising to the top is an example of a condition in which the gas void fraction is unrelated to the gas volume fraction.

Although the single phase mass flow of the gas and liquid within a Coriolis meter can generally be determined with great accuracy, the resulting gas void fraction within the flow tubes of the Coriolis meter remains uncertain due to a variety of physical effects including gas going into and out of solution into the liquid, pressure changes within the flow path from the injection point, through any associated piping, and through the flow tubes of the Coriolis meter, and gas holdup and/or liquid holdup associated with slippage among the gas and liquid phases through the flow tubes. Given the often large variation in cross-sectional area of the piping in and around the flow tubes 14 of a Coriolis meter 670 (FIG. 26) and variation in the orientation of piping sections and flow tubes with respect to gravity, as well as pressure variations, and unknown and uncertain time scales associate with gas going into and out of solution, the actual gas void fraction within any given section of piping typically varies spatially in a complex manner, and has spatially-averaged and temporally averaged mean properties that can differ significantly from a reference gas void fraction interpreted based on single phase injection rates at a given location upstream of the Coriolis meter. Additionally, the variance between the spatially averaged gas void fraction and a gas volume fraction measured at a given injection will in general vary with flow conditions.

Additionally, and for similar reasons, gas volume fraction measurements utilizing gas void fraction measured utilizing devices on the piping network in proximity to the Coriolis meter, such as a clamp-on GVF meter offered by Cidra Corporation, will also, in general, differ from the gas void fraction within the flow tubes of the Coriolis meter due to differences in the mixture flow velocity, pressure, and orientation of pipe in proximity to the Coriolis meter to mixture flow velocity, pressure and orientation within the flow tubes of the Coriolis meter.

Inventively, implementations of the current disclosure use measuring the process fluid sound speed within the flow tubes of a Coriolis meter and interpreting the gas void fraction within the flow tubes of a Coriolis meter from the measured sound speed of a bubbly liquid has been discovered to be one of the most practical and accurate methods to determine the gas void fraction of a bubby liquid within the flow tubes of a Coriolis meter and to use a process fluid sound speed measurement from within the flow tubes of a Coriolis meter as both part of a training data from which an optimized Coriolis correction correlation is developed to correct the output of a Coriolis meter operating on bubbly liquids as well as a correlation input parameter.

Also disclosed here are inventive methods that utilized Coriolis meter diagnostic metrics in the developing of optimized Coriolis correction correlations using a training data set to reduce the errors in the mass flow and/or density of bubbly fluids and a correlation input parameter Coriolis meter diagnostic metrics typically include a metric indicative of the excitation energy (EE) input into the flow tubes and a metric indicative of the vibrational amplitude (VA) of the flow tubes. For most Coriolis meters, the EE and VA can be monitored as a diagnostic output from the Coriolis transmitter. Coriolis meters of the prior art are typically designed to maintain a constant vibrational amplitude of the flow tubes.

The excitation energy required to maintain a prescribed amplitude of the tube vibration is monitored and a diagnostic signal indicative of this excitation energy is output. For single phase fluids, a prior art Coriolis meter is typically designed to be able to provide sufficient excitation energy to maintain the prescribed vibration amplitude. However, as particles, including bubbles or other particles are introduced to the process fluid, the amount of excitation energy required to maintain the prescribed vibration amplitude typically increases. A control algorithm within the prior art Coriolis meter responds to this increase in required energy by increasing the excitation energy to the flow tubes to maintain the prescribed vibration amplitude. For bubbly liquids with all other conditions constant, the amount of excitation energy required typically qualitatively scales with gas void fraction. i.e., as the gas void fraction increases, the excitation energy required to maintain the prescribed vibration amplitude increases. This continues until the excitation energy reaches a limit, at which point the excitation energy is said to be saturated. As the gas void fraction increases beyond where the excitation energy saturates, the vibration amplitude of the tubes decreases.

Excitation energy metrics and vibration amplitude metrics have been used as qualitive indicators of entrained gas levels. First-principles models of Coriolis meters operating on fluids with particles predict that the mechanisms of decoupling [Basse 15] and compressibility [Zhu 9] associated with changes in gas void fraction can lead to changes in parameters derived from excitation energy metrics (EE) and vibration amplitude metrics (VA). Specifically, Zhu indicates that the ratio of the excitation energy to the vibrational amplitude of a flow tube is indicative of the damping associated with the primary vibrational mode of the Coriolis meter. Zhu developed an analytical model in which he developed a mathematical model which predicts a relationship between a Coriolis damping parameter, defined by Zhu as the ratio of excitation energy to vibration amplitude to the speed of sound of the process fluid. The analytical model contains many assumptions and requires some constants to be determined empirically. Zhu proposed utilizing this Coriolis damping parameter to correct the density and mass flow of Coriolis meters utilizing mathematical corrections based on a reduced-order, analytical model of errors in Coriolis meters due to bubbly flows.

This disclosure utilizes reduced order models to identify measurable non-dimensional parameters for use in developing and applying optimized Coriolis correction correlations to mitigate errors in Coriolis meters. A reduced pressure, as used herein, can be defined as the pressure of the process fluid non-dimensionalized by the product of the liquid density ρ_{liq} and the square of the Coriolis vibrational frequency times the radius of the flow tubes

$$2 π {f}_{tube} \frac{D}{2}$$

as shown below:

$${P}_{red} ≡ \frac{γ P}{{{ρ}_{liq} ( 2 π {f}_{tube} \frac{D}{2} )}^{2}} \approx \frac{a}{{f}_{red}^{2}} \qquad ( Equation 8 )$$

Where γ is the polytropic exponent governing the compressibility of the gas bubbles and P is the pressure. As such, the reduced pressure P_{red} is a Coriolis operating parameter. The reduced pressure also approximates the ratio of the gas void fraction α to the square of the reduced frequency

$${f}_{red}^{2}$$

and to curvature to the diverse of the compressibility influence parameter Γ disclosed hereinafter.

$${P}_{red} ≡ \frac{γ P}{{{ρ}_{liq} ( 2 π {f}_{tube} \frac{D}{2} )}^{2}} = \frac{α}{{f}_{red}^{2}} = \frac{1}{Γ} \qquad ( Equation 9 )$$

Within Hemp's reduced order model, the reduced pressure is a measure of the relative importance of decoupling effects compared to compressibility effects. For low reduced pressures, the effects of compressibility become more important relative to decoupling effects. For high reduced pressures, the effects of compressibility become less important relative to decoupling effects.

Inventively the use of a training data set to develop optimized Coriolis correction correlations to correct for the errors associated with Coriolis meters operating on liquid continuous flows with particles is disclosed herein. Training data sets include information from a plurality of data points from which one or more Coriolis error parameters can be determined for each data point for a Coriolis meter operating over a range of process fluid parameters and Coriolis operating parameter which span a range of gas void fractions or particle volume fraction, and for which other process fluid parameters and or other Coriolis operating parameters are known. Inventively, for training data sets utilized herein, these other process fluid parameters and or other Coriolis operating parameters include at least one of a process fluid sound speed, a gas void fraction, a reduced frequency, an excitation energy metric, or a vibrational amplitude metric for at least two data points in the training data set. The optimized Coriolis correction correlations developed from the training data sets are then applied to correct for errors in measured mass flow, density and/or volumetric flow from Coriolis meters which have similar design parameters as the Coriolis meter from which the training data set was recorded and from which Coriolis meters are operating on liquids with entrained particles over a similar range of conditions spanned by the training data set

Disclosed herein are examples of optimized Coriolis correction correlations developed utilizing experimentally determined training data sets. It is recognized by those skilled in the art that training data sets can be determined in a variety of ways including experimentally, analytically, or computationally. Analytical models are defined here as any mathematical model. Computational models refer to models that utilized computation fluid dynamic and/or computational structural dynamic modelling techniques. It is also recognized that training data sets may include data obtained using various methods.

These examples of optimized Coriolis correction correlations provide correlations that are applicable for Coriolis meters of the same or similar design parameters, such as Coriolis meters of the same model number or the same fundamental design parameters such as tube geometry and electronic characteristics. For purposes of this disclosure, two Coriolis meters meeting these conditions are referred to as Coriolis meters of the same type. As such, any correlation developed using a training data set from a Coriolis meter of a given type, would, in general, be expected to be applicable for correcting other Coriolis meters of the same type.

Methods to correct both the mass flow and the density of prior art Coriolis meters operating in bubbly flows are inventively disclosed herein. Reduced order models of Coriolis meters indicate that error mechanisms associated with the mass flow and density reported by Coriolis meters operating on bubbly flows are likely highly correlated. In many situations, the density of the liquid phase is either known, or can be determined utilizing either methods taught within this disclosure or other methods such as those disclosed in co-pending PCT publication number WO2021/167921A1 (the '921 application), the disclosure of which is incorporated herein in its entirety, or by other methods such as sampling. In these cases, it be can advantageous to calculate density error parameter on a real time basis and utilize this density error parameter as an input correlation parameter for optimized Coriolis correction correlations used to correct the mass flow of a Coriolis meter operating on liquids with entrained particles. The '921 application teaches the use of process fluid sound speed measurement to reduce errors in the density of the liquid phase of bubbly mixtures. Specifically, the '921 application teaches the use of data points from multiple instances from a given Coriolis meter operating on a bubbly liquids with similar fluid properties but with varying gas void fractions. These multiple measurements from a Coriolis meter are utilized as input to an optimization that, under specific assumptions, are used to determine a density of the liquid phase of process fluid based on information obtained contemporaneously from a Coriolis meter operating on a bubbly liquids without an additional reference meter. This approach differs from the current invention in that it does not utilize any reference measurements and does not utilize a training data set.

In many cases, Coriolis meters are applied to bubbly liquids in applications for which either there is no gas void fraction measurement available, or for which the gas void fraction is assumed to be small or negligible. In these applications, the measured density of the bubbly mixture is often interpreted as the density of the liquid phase. Thus, the difference between the measured density and that of the liquid phase of bubbly mixtures is referred to herein as an error in the measured density. It is recognized that for typical mixtures in which the density of the gas phase is less than that of liquid, the density of a bubby mixture is less than the density of the liquid phase. For applications for which the density of the gas phase is small compared to that of the liquid, the actual density of a bubbly mixture can be well approximated by:

$${ρ}_{mix} = {ρ}_{liq} ( 1 - α ) \qquad ( Equation 10 )$$

Where α is the gas void fraction.

Embodiments of the methods described herein utilize a measured, sub-bubble resonant sound speed of the process fluid. The sub-bubble-resonant sound speed of a bubbly liquid can be related to the gas void fraction through Wood's equation disclosed herein above. Sub-bubble resonant sound speed of a bubbly liquid is a term used in the art to describe the propagation speed of sound waves associated with frequencies which are significantly lower than the radial volumetric resonant frequency of the bubbles within the liquid. The radial volumetric resonant frequency of a spherical bubble within liquid can be expressed as function of the radius of the bubble by Minnaert's equation:

$${ω}_{0} = \frac{{c}_{gas}}{{R}_{o}} \sqrt{3 \frac{{ρ}_{gas}}{{ρ}_{liq}}} \qquad ( Equation 11 )$$

Where Rₒ is the mean radius of the oscillating bubble, c_{gas} is the speed of sound in the gas contained in the bubble, and ρ_{gas} and ρ_{liq} are the ambient densities of the gas and of the liquid, respectively. As a numerically example, the natural frequency of a 1 mm air bubble within water at 1 bar pressure is ˜3000 Hz. At 10 bar, a 1 mm bubble would have a natural frequency of ˜10,000 Hz.

For sound propagating within a conduit for which the wavelength is large compared to both fluid inhomogeneities and the cross-sectional length scale of the conduit and for which the frequency is significantly lower than the bubble resonant frequency associated with the majority of bubbles, Wood's equation [12,13] relates the sound speed, aₘᵢₓ, and density, ρₘᵢₓ of a mixture consisting of “N” components to the volumetric phase fraction, φᵢ, density, ρᵢ and sound speed, aᵢ of each component of the mixture:

$$\frac{1}{{ρ}_{mix} {a}_{mix}^{2}} = {\sum }_{i = 1}^{N} \frac{{φ}_{i}}{{ρ}_{i} {a}_{i}^{2}} + σ \qquad ( Equation 12 )$$

The compliance of the conduit, σ, given below for a thin-walled, circular cross section conduit of diameter D and wall thickness of t and modulus of E, also influences the propagation velocity:

$$σ = \frac{D - t}{Et} \qquad ( Equation 13 )$$

The mixture density, ρₘᵢₓ, is given by:

$${ρ}_{mix} = {\sum }_{i = 1}^{N} {ρ}_{i} {φ}_{i} \qquad ( Equation 14 )$$

For bubbly liquids, Wood's equation can be expressed as a combination of a gas and a liquid phase as follows:

$$\frac{1}{{ρ}_{mix} {a}_{mix}^{2}} = \frac{α}{{ρ}_{gas} {a}_{gas}^{2}} + \frac{1 - α}{{ρ}_{liq} {a}_{liq}^{2}} + \frac{D - t}{Et} \qquad ( Equation 15 )$$

Where the mixture density is given by:

$${ρ}_{mix} = α {ρ}_{gas} + ( 1 - α ) {ρ}_{liq} \qquad ( Equation 16$$

The mixture speed of sound can be expressed as a function of the gas void fraction and the fluid properties and properties of the conduit as follows:

$${a}_{mix} = \frac{1}{\sqrt{{ρ}_{mix} ( \frac{α}{{ρ}_{gas} {a}_{gas}^{2}} + \frac{1 - α}{{ρ}_{liq} {a}_{liq}^{2}} + \frac{D - t}{Et} )}} \qquad ( Equation 17 )$$

For cases in which the volumetrically-weighted compressibility of the gas phase is dominant, which is typically a good approximation at low pressures with gas void fractions >˜0.1%, the gas void fraction scales with the inverse of the square of the process fluid sound speed:

$$α ≅ \frac{γ P}{{ρ}_{liq} {a}_{mix}^{2}} \qquad ( Equation 18 )$$

Where γ is the polytropic exponent governing the compressibility of the gas bubbles and P is the process pressure. The sound speed of the gas is expressed as a function of gas temperature, T, the gas constant, R, and the polytropic exponent γ.

$${a}_{gas} = \sqrt{γ RT} \qquad ( Equation 19 )$$

The appropriate polytropic exponent depends on the frequency of the sound waves compared to a thermal relaxation frequency set by the bubble diameter and the thermal diffusivity of the gas [14]. For air bubbles, this polytropic exponent can range from isothermal conditions, γ=1.0, for low frequencies compared to the thermal relaxation frequency, to isentropic conditions, γ=1.4, for high frequencies compared to the thermal relaxation frequency.

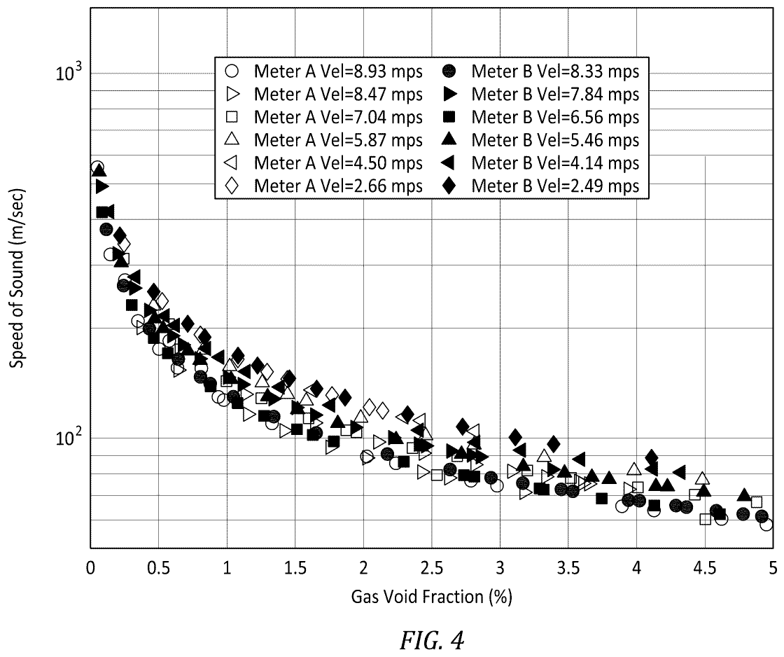

Referring to FIG. 4, there is the measured sound speed is plotted versus this interpreted gas void faction using data from two Coriolis meters, Coriolis meter A and Coriolis meter B. As shown, the process fluid sound speed ranges from ˜1500 m/sec for the liquid-only phase, the ˜60 m/sec for gas void fractions approaching 5%.

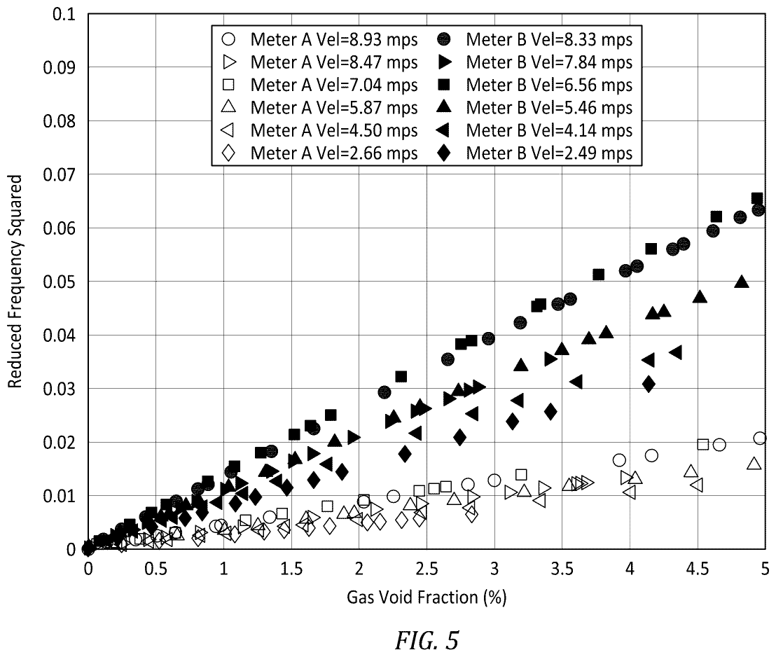

Referring to FIG. 5 there is shown the square of the reduced frequency from each of the Coriolis meters for the same data sets plotted as a function of interpreted gas void fraction. The two meters have flow tubes with similar diameters; however, Coriolis meter B has a nominal water-filled tube vibrational frequency of ˜2.2 times that of Coriolis meter A, resulting in the square of the reduced frequency being ˜5× larger for Coriolis meter B compared to Coriolis meter A.

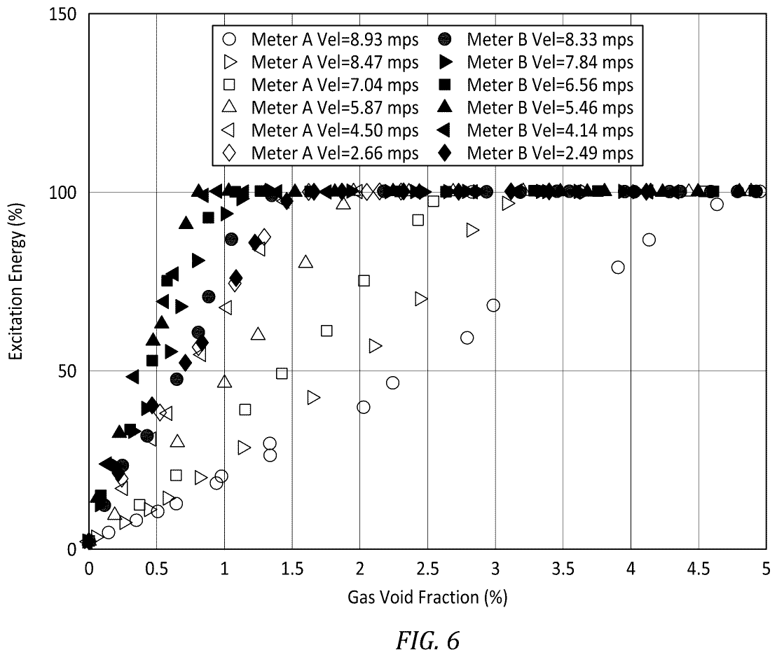

FIG. 6 shows the excitation energy metric from each of the Coriolis meters for the same data sets plotted as a function of interpreted gas void fraction. As shown, the excitation energy metric increases with gas void fraction for each meter at each condition until it reaches a saturation, defined herein as 100% percent of the saturation limit for each Coriolis meter.

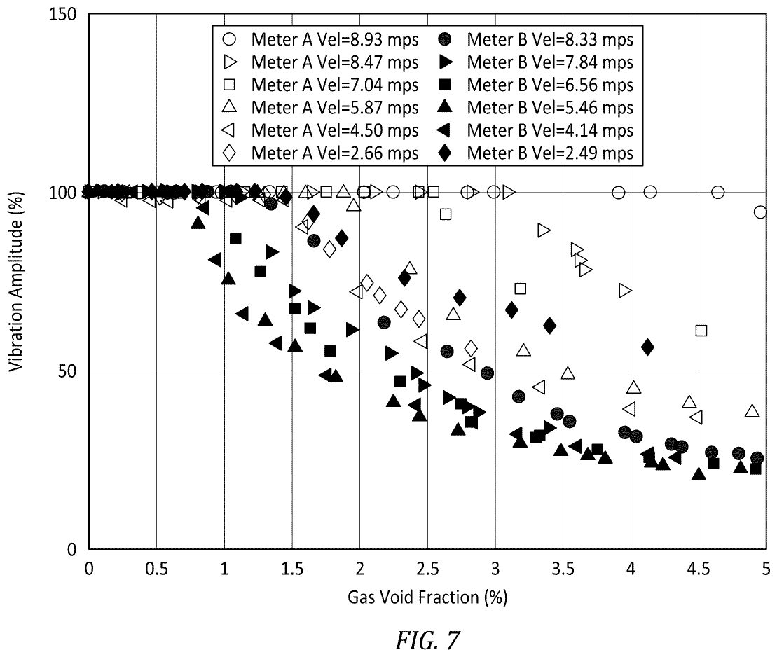

FIG. 7 shows the vibration amplitude from each of the Coriolis meters for the same data sets plotted as a function of interpreted gas void fraction. As shown, the vibration amplitude is constant with increasing gas void fraction until, as indicated in FIG. 6, the excitation energy metric becomes saturated, at which point, the amplitude of the vibration of the tubes decreases with additional gas void fraction.

Although the methodologies disclosed herein is not limited to any specific embodiment for the form of the correlation, one suitable formulation uses linear regression to quantify a correlation weighting parameters that define an optimized Coriolis correction correlation among a correlation output parameter, the density error parameter, Ψ, and a group of correlation input parameters. In this particular implementation of this method, the density error parameter, Ψ, is assumed to be expressed as a linear function of a combinations of correlation input parameters as follows:

$${Ψ}_{i} = A {α}_{i} + B {f}_{{red}_{i}}^{2} + C \frac{{EE}_{i}}{{VA}_{i}} \qquad ( Equation 20 )$$

Where VAᵢ is the vibrational amplitude and EEᵢ is the excitation energy disclosed herein above. Where the correlation weighting parameters, in this example, are the scalar quantities A,B,C. These correlation weighting parameters are determined through linear regression for a training data set.

It should be noted that the optimized Coriolis correction correlation utilizes the ratio of the excitation energy metric divided by the vibration amplitude,

$$\frac{{EE}_{i}}{{VA}_{i}} .$$

as a correlation input parameter. This combination has advantageous properties of being continuous through saturation and, in general, often maintains a monotonic relationship with the density error function and other parameters such as gas void fraction beyond conditions at which the energy excitation metric saturates.

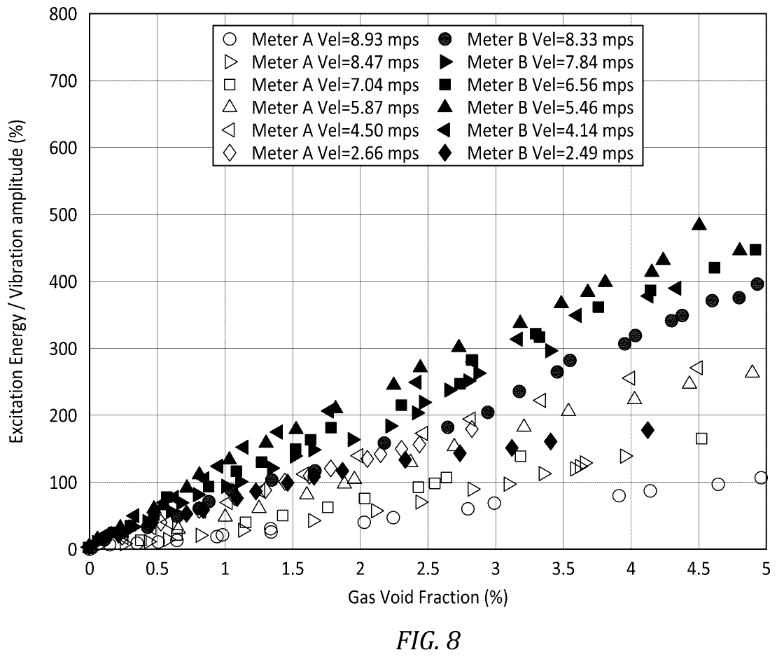

FIG. 8 is a graphical representation of the ratio of the excitation energy to the vibrational amplitude versus the gas void fraction. As shown, the ratio of the excitation energy to the vibrational amplitude varies monotonically with gas void fraction, varying smoothly through the saturation conditions. Note that there are many ways to combine the excitation energy metric and the vibrational amplitude metric to create a parameter that varies smoothly through energy excitation saturation, the use of which in optimized Coriolis correction correlations to correct measured Coriolis output parameters are considered within the scope of this current invention

Additionally, linear regression in this disclosure can utilize the square of the measured parameters (for example reduced frequency) and can utilize cross products and other combinations of the measured parameters as correlation input parameters. For example, the reduced frequency and the gas void fraction are themselves “engineered” parameters based on process fluid sound speed and other information about the operating conditions.

Specifically, for a training data set with N data points, the density error parameter and the correlation input parameters are used to form N equations for M unknowns, where M the unknowns are the correlation weighting parameters, A,B,C, as shown below:

$${⌊ {α}_{i} {f}_{{red}_{i}}^{2} {EE}_{i} / {VA}_{1} ⌋}_{NXM} {\{ \begin{matrix}A \\ B \\ C\end{matrix} \}}_{MX 1} = {⌊ {Ψ}_{i} ⌋}_{NX 1} \qquad ( Equation 21 )$$

For conditions where there are more data points than correlation weighting parameters, the set of N equations associated with the N data points from the training set represents an over-constrained, linear set of N equations for the M unknown correlation weighting parameters which can be expressed in standard form as follows.

$${A}_{NXM} {X}_{MX 1} = {B}_{NX 1} \qquad ( Equation 23 )$$

An optimized least squares solution for the correlation weighting parameters is given by:

$${X}_{{opt}_{MX 1}} = {( {A}_{NXM}^{T} {A}_{NXM} )}^{- 1} {A}_{NXM}^{T} {B}_{NX 1} \qquad ( Equation 24 )$$

Where T denotes the matrix transpose, and (−1) denotes the matrix inverse. The least squares optimization spans the range of flow parameters over which the reference data set was recorded. It is anticipated that Coriolis meters of the same type can utilize the same correlation constants. Once the correlation weighting parameters are determined, the correlation for density error term, Ψ_{c}_{ᵢ}, can used to determine an estimate for the density error parameter based on measured and available parameters.

$${Ψ}_{{c}_{i}} = {⌊ {α}_{i} {f}_{{red}_{i}}^{2} \frac{{EE}_{i}}{{VA}_{i}} ⌋}_{1 X M} {\{ \begin{matrix}{A}_{opt} \\ {B}_{opt} \\ {C}_{opt}\end{matrix} \}}_{MX 1} \qquad ( Equation 25 )$$

The estimated density error parameter, Ψ_{c}_{ᵢ}, can then be used to determine a corrected mass flow based on the measured mass flow as follows:

$${ρ}_{{liq}_{i}} ≡ \frac{{p}_{meas}}{I - {Ψ}_{{c}_{i}}} \qquad ( Equation 26 )$$

More, or fewer, parameters and combinations of parameters can be used in the formulation of the correlation for the density error parameter, Ψ_{c}_{ᵢ} without departing from the methodology disclosed herein.

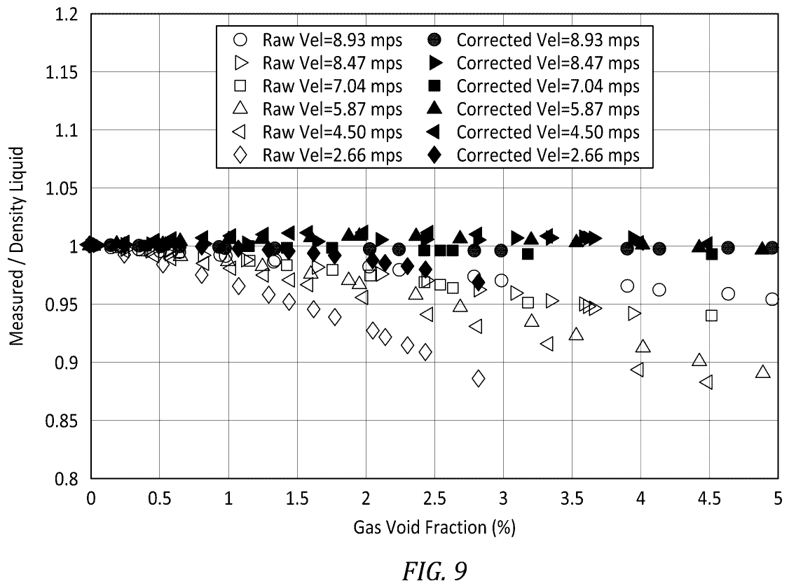

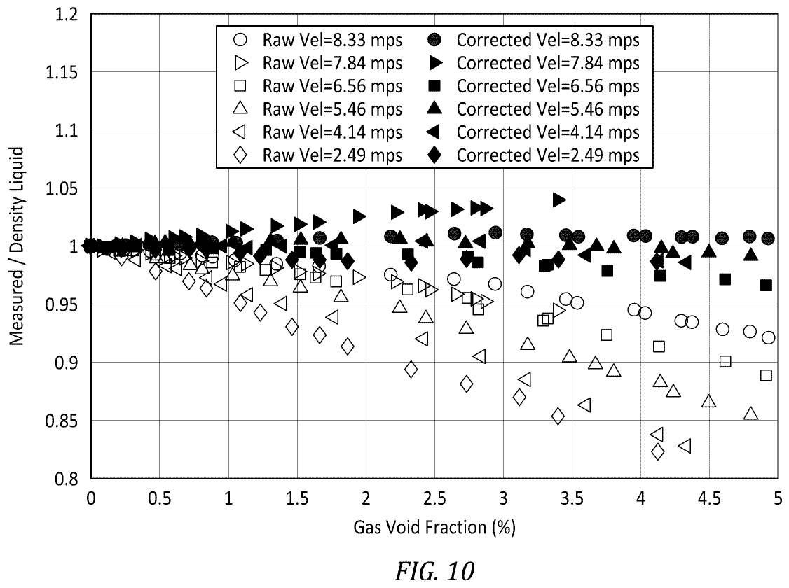

Referring next to FIGS. 9, 10, there is shown the method disclosed herein above applied to determine an improved liquid density for the data shown above. The optimized correlation parameters are shown in the table below:

TABLE 2

| | A | B | C |
|---|---|---|---|
| Meter A | 2.65 | −5.53 | 0.024 |
| Meter B | 7.07 | −4.30 | 0.002 |

Application of the method reduced the root mean square of the error in the liquid density for Coriolis meter A from 4.55% to 0.69% and for Coriolis meter B from 6.38% to 1.21%.

Another implementation of the current invention is the use of 1) measured parameters based at least in part on a measured process fluid sound speed, 2) excitation energy diagnostics and 3) vibrational amplitude diagnostics as correlation input parameters in an artificial neural net (ANN) formulation to minimize errors in interpreted liquid density of Coriolis meters operating on bubbly liquids.

Neural networks are “adaptive systems that learn by using interconnected nodes” as disclosed at the following link https://www.mathworks.com/videos/getting-started-with-neural-networks-using-matlab-1591081815576.html. Tools to implement and train neural networks are widely available, and variations in parameters of the any neural network implementation remains within the scope of this invention. The neural networks utilized in this disclosure were implemented and trained utilizing the Matlab Deep Learning Toolbox, commercially available from the MathWorks, Natick, MA. Note the terms artificial neural network and neural network are used interchangeably in this disclosure.

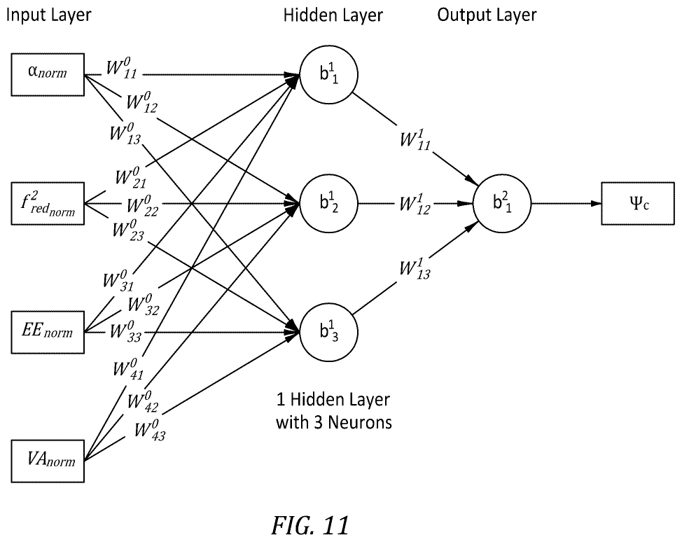

FIG. 11 shows a schematic of a neural network as an example of an implementation of methods in accordance with the current disclosure. The neural network utilizes four normalized inputs, based on the gas void fraction, α, the reduced frequency squared,

$${f}_{red}^{2} ,$$

the excitation energy diagnostic, EE, and the vibrational amplitude diagnostic, VA, as inputs to a neural network with a single hidden layer with 3 neurons and a output layer consisting of a single neuron.

The inputs are normalized as follows using a as an example:

$${α}_{{norm}_{n}} = ( {α}_{n} - min ( {α}_{1 : N} ) ) / ( max ( {α}_{1 : N} ) - min ( {α}_{1 : N} ) ) \qquad ( Equation 27 )$$

In this formulation, the weighted inputs to each neuron are summed and a bias is added to this sum. This result is then used as input to an activation function to produce the output of the neuron. The activation function for the hidden layer is a hyperbolic tangent function, and the activation function for the output layer is linear.

For example, the outputs of the 3 neurons in the hidden layer are given by:

$$\{ \begin{matrix}{a}_{1}^{1} \\ {a}_{2}^{1} \\ {a}_{3}^{1}\end{matrix} \} = tanh ( ⌊ {W}_{ij}^{0} ⌋ \{ \begin{matrix}{α}_{norm} \\ {f}_{{red}_{norm}}^{2} \\ {EE}_{norm} \\ {VA}_{norm}\end{matrix} \} + \{ \begin{matrix}{b}_{1}^{1} \\ {b}_{2}^{1} \\ {b}_{3}^{1}\end{matrix} \} ) \qquad ( Equation 28 )$$

And the output of the network is are correlation predicted values for density error parameter associated with the correlation input parameters and is given by:

$$\{ {a}_{1}^{2} \} = ( ⌊ {W}_{i j}^{1} ⌋ \{ \begin{matrix}{a}_{1}^{1} \\ {a}_{2}^{1} \\ {a}_{3}^{1}\end{matrix} \} + \{ {b}_{1}^{2} \} ) = {Ψ}_{correlation} \qquad ( Equation 29 )$$

The process of training a neural network involves an optimization procedure in which the optimized correlation weighting parameters (the weights (W) and biases (b)) are determined. Given the often large number of weighting parameters, the process of training a neural network can be mathematically complex, however, many tools are available which leverage many techniques to train neural networks. The examples network shown in this disclosure were trained utilizing the Matlab Deep Learning toolbox. The neural network used in this example has 4 inputs, one hidden layer, with 3 neurons, and a single neuron output layer. Training this ANN involves optimizing 12+3 weights, and 3+1 biases for a total of 19 scalar correlation weighting parameters.

A neural network as disclosed directly herein above was trained utilizing reference data sets for each for the Coriolis meters disclosed herein. 70% of the data points in each reference data set were randomly selected for the training set used in an optimization process to determine optimized weighting and bias parameters for each data set. The trained neural network was then applied to all of the data points in reference data set. It should be noted that the fraction of data points of a reference data set that is used as the training data set is arbitrary with respect to the inventiveness of this disclosure.

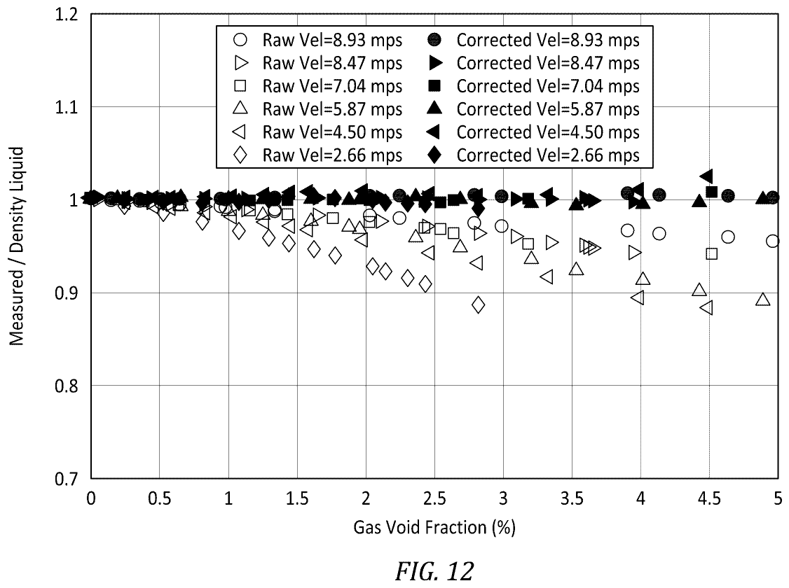

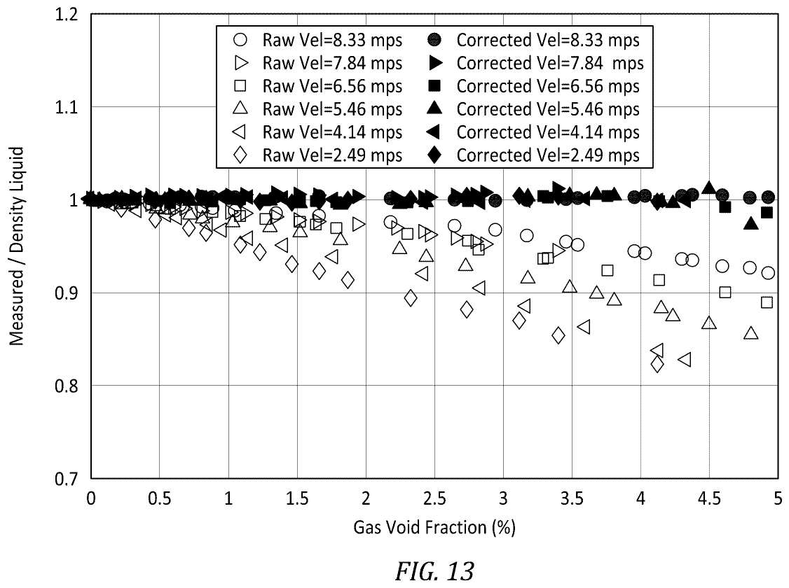

Referring now to FIGS. 12, 13 there is shown a graphical representation of the measured density, normalized by the reference liquid density, and the liquid density determined utilizing the trained neural network, normalized by the liquid density for the two Coriolis meters. As shown, the trained, single layer, 3-neuron, neural network which utilized the gas void fraction, the reduced frequency squared, the excitation energy metric, and the vibrational amplitude diagnostic as correlation input parameters provides an effective means to reduce the error in interpreted liquid density for each Coriolis meter operating on bubbly liquids. As shown, for Coriolis meter A, the root mean square of the error in the mass flow error parameter was reduced from 4.55% to 0.41%, and for Coriolis meter B, the root mean square of the error in the mass flow error parameter was reduced from 6.38% to 0.42%.

The optimized weighting and bias parameters for each meter are listed below:

For Coriolis meter A:

$${W}_{ij}^{1} = ⌊ \begin{matrix}1.6867 & - 1.5171 & 1.0707 & 0.4282 \\ 1.3174 & - 0.5393 & 0.6275 & - 1.0492 \\ 1.2365 & - 0.1915 & 0.5358 & - 0.4764\end{matrix} ⌋$$

$${W}_{i , j}^{2} = \{ \begin{matrix}1.0427 & 0.3064 & 0.1547\end{matrix} \}$$

$${b}_{j}^{1} = \{ \begin{matrix}- 1.8688 \\ - 0.173 \\ 2.3875\end{matrix} \} {b}_{j}^{2} = \{ 0.0529 \} -$$

### And for Coriolis Meter B:

$${W}_{ij}^{1} = ⌊ \begin{matrix}- 0.3245 & - 1.409 & 0.0425 & - 0.3009 \\ - 0.0244 & - 0.3441 & 0.2122 & - 2.2699 \\ 5.577 & - 8.3566 & 0.0736 & 0.0251\end{matrix} ⌋$$

$${W}_{i , j}^{2} = \{ \begin{matrix}1.5334 & - 2.9342 & 1.0442\end{matrix} \}$$

$${b}_{j}^{1} = \{ \begin{matrix}- 2.7764 \\ 2.5530 \\ - 3.7006\end{matrix} \} {b}_{j}^{2} = \{ 1.7323 \}$$

The current novel and innovative approach of utilizing a process fluid sound speed measured across the flow tubes of a Coriolis meter in both the training data set and in the formulation of correlation input parameters to correct for errors in the Coriolis meter operating on bubble flows has many advantages. These advantages include: 1) the sound speed of the process fluid within the flow tubes of the Coriolis meter is more directly related to the errors in the Coriolis meter than a gas volume fraction measured at a reference gas injection point; and 2) since process fluid sound speed measurements are typically available in the laboratory (to develop a training set) and in the field (for use as correlation input parameters), it is practical and advantageous to utilize a process fluid sound speed measurement measured essentially the same way for use in the training data set and for use as correlation input parameters. Whereas, since reference gas void fraction measurement are typically not available in the field, training sets developed utilizing reference gas void fraction measurement do not have this advantage, i.e. it is best practice to use a training data set that includes measurements that are available for use as correlation input parameters when applying the optimized Coriolis correction correlations to correct Coriolis meters.

And since flow tube orientation can impact Coriolis error parameters for Coriolis metering operating on liquids with entrained particles, it is also preferred to develop the training data sets and apply any correlation-based Coriolis corrections using Coriolis meters of the same type and Coriolis meter operating in the same orientation with respect to gravity. For example, utilize a flag-mounted with vertical flow upwards for both the training data set from which the optimized Coriolis correction correlation is developed and for the Coriolis meter to which the optimized Coriolis correction correlation is applied.

It has been discovered that, while including speed-of-sound-based variables such as gas void fraction and the reduced frequency as correlation input parameters for the density error will typically improve the accuracy of the corrected liquid density flow of bubbly fluid, correlations which do not utilize speed-of-sound-based variables can still provide significant improvements in the accuracy of the corrected mass flow compared to the raw mass flow. These correlations are particularly useful for applications for which a speed of sound measurement is not available.

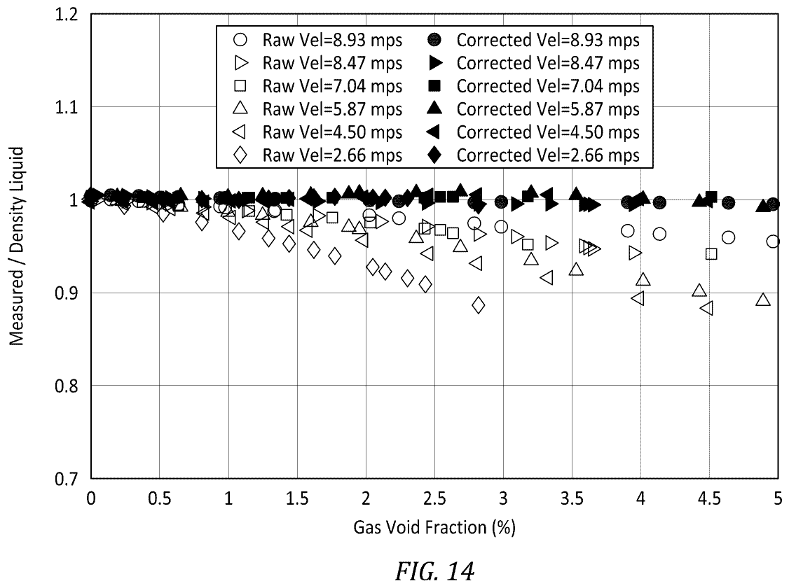

Referring to FIG. 14 there is shown a graphical representation of the measured normalized density and corrected normalized liquid density corrected using a by a 3 neuron, single hidden level, neural net utilizing 2 inputs: the reduced pressure and excitation energy (EE) diagnostic divided by the vibration amplitude (VA). For brevity and clarity, only results from Coriolis meter A are shown, however, the results from Coriolis meter B are similar, and the results from each optimization are reported in this disclosure. This network was trained with the same procedure as described for the previous neural network herein above. As shown, the error in the density error parameter was reduced from 4.55% rms to 0.35% rms for Coriolis Meter A. The same approach applied to Coriolis B resulted in density error function being reduced from 6.38% rms to 0.47% rms for Coriolis Meter B.

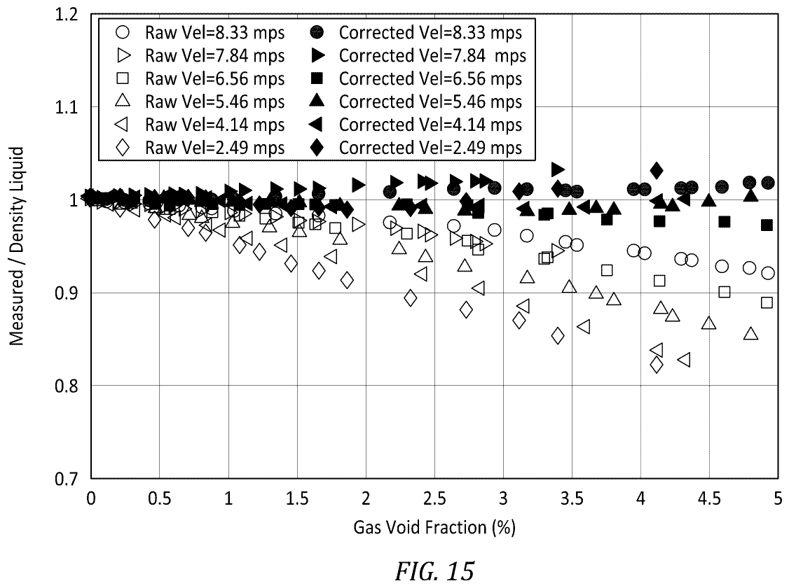

Referring next to FIG. 15 there is shown the normalized measured Coriolis meter density and normalized corrected liquid density as corrected using a 3 neuron, single hidden level, neural net with 2 correlation inputs parameters: the gas void fraction and the reduced frequency square for Coriolis Meter B. For brevity and clarity, only the results from Coriolis meter B are shown, however the results for Coriolis Meter A are similar in character and the results from both optimizations are reported below. This network was trained with the same procedure as described for the previous neural network. The error in the density flow error parameter was reduced from 4.55% rms to 0.65% rms for Coriolis Meter A, and from 6.38% rms to 1.04% rms for Coriolis Meter B. This configuration would be useful for Coriolis meters for which signals indicative of the process fluid sound speed are available, but signals indicative of the excitation energy and/or vibration amplitude are not available.

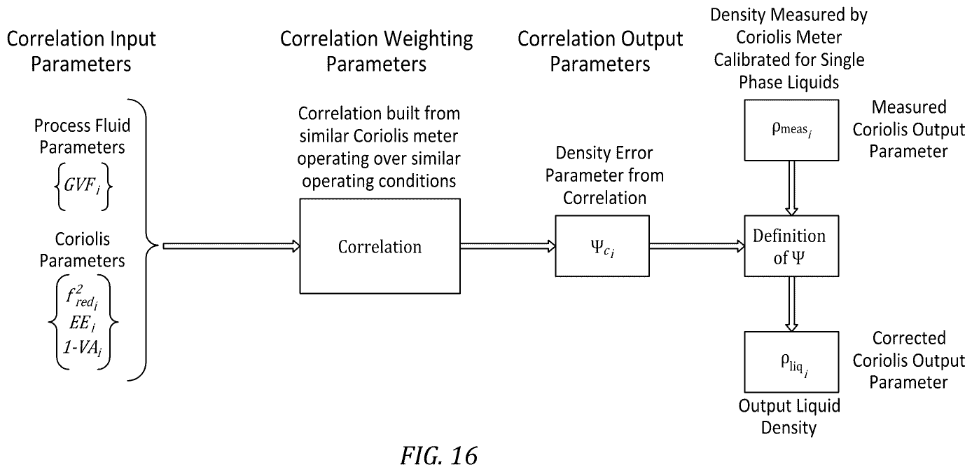

Referring now to FIG. 16, there is shown an implementation of the approach outlined in this disclosure. A set of measured and engineered correlation input parameters that includes at least one of: a parameter based at least in part on a measured process fluid sound speed, a parameter that is indicative of at least one of an excitation energy or a vibrational amplitude. The correlation represents a mapping of the measured and engineered correlation input parameters to a correlation output parameter, in this case, a density error function. The determined value for the density error parameter from the correlation, is then used with the measured density from Coriolis meter, to determine a corrected liquid density of the bubbly liquid within the Coriolis meter under test.

The parameters of the neural networks used in developing the optimized Coriolis correction correlations can be varied without departing from the current disclosure. For example, additional neurons could be utilized, additional hidden layers, different training rules, different activations functions are all examples variation in the parameters that are consistent with the current disclosure.

### Correcting Mass Flow

Methods disclosed herein further include methods to provide an improved measure of the mass flow of the bubbly liquid process fluid.

Although the methodology disclosed herein is not limited to any specific embodiment for the form of the optimized Coriolis correction correlation, one suitable implementation uses a linear regression to quantify correlation weighting parameters which correlate a mass flow error parameter, ¢, and measured and engineered parameters utilized as correlation input parameters. The mass flow error parameter is assumed to be expressed as a linear function of a combination of a set of correlation input parameters as follows:

$${Φ}_{{c}_{i}} = A {Ψ}_{i} + B {α}_{i} + {Cf}_{{red}_{i}}^{2} + D {Ψ}_{i} {α}_{i} + E {Ψ}_{i} {f}_{{red}_{i}}^{2} + F {α}_{i} {f}_{{red}_{i}}^{2} + {GEE}_{i} + H ( 1 - {VA}_{i} ) + I {Ψ}_{i} {EE}_{i} + J {Ψ}_{i} ( 1 - {VA}_{i} ) + K {Ψ}_{i}^{2} \qquad ( Equation 30 )$$

Where the correlation weighting parameters A,B,C,D,E,F,G,H,I,J,K are determined through linear regression for a training data set. It should be appreciated by those skilled in the art that the linear regression utilizes (1-VAᵢ) as an “engineered” parameter instead of the vibration amplitude itself in an effort to improve the ability of the linear regression to fit the data. Additionally, the linear regression utilizes the square of the reduced frequency instead of the reduced frequency itself, as well as cross products of the measured parameters. It is also important to note in this example that the density error parameter, a Coriolis error parameter, is utilized as a correlation input parameter in the correlation for the mass flow error parameter, which is also a Coriolis error parameter.

Specifically, the N data points in the training data set were used to form N equations for M unknowns, where the M unknowns are the correlation weighting parameters, as shown below:

$${⌊ {Ψ}_{i} {α}_{i} {f}_{r e {d}_{i}}^{2} {Ψ}_{i} {α}_{i} {Ψ}_{i} {f}_{r e {d}_{i}}^{2} {α}_{i} {f}_{r e {d}_{i}}^{2} {EE}_{i} ( 1 - {VA}_{i} ) {Ψ}_{i} {EE}_{i} {Ψ}_{i} ( 1 - {VA}_{i} ) {Ψ}_{i}^{2} ⌋}_{NXM} {\{ \begin{matrix}A \\ B \\ C \\ D \\ E \\ F \\ G \\ H \\ I \\ J\end{matrix} \}}_{MX 1} = {⌊ {Φ}_{i} ⌋}_{NX 1} \qquad ( Equation 31 )$$

Ideally, the training data set would consist of data from a given Coriolis meter type operating over a range of parameters. Ideally, the resulting optimized Coriolis correction correlation would be applied to a Coriolis meter of the same type, operating in the same orientation with respect to gravity, over a range of parameters spanned by the training data set. For conditions where there are more data points than unknowns parameters, the N equations represent an over-constrained, linear set of equations which can be expressed in standard form as follows.

$${A}_{NXM} {X}_{MX 1} = {B}_{NX 1} \qquad ( Equation 32 )$$

An optimized least squares solution for the correlation weighting parameters is given by:

$${X}_{{opt}_{MX 1}} = {( {A}_{NXM}^{T} {A}_{NXM} )}^{- 1} {A}_{NXM}^{T} {B}_{NX 1} \qquad ( Equation 33 )$$

The least squares correlation optimization spans the range of flow parameters over which the reference data set was recorded. Once determined, optimized correlation weighting parameters can be applied to a set of correlation input parameters determined from a Coriolis meter of the same type, operating in conditions that are spanned by the training data set, to determine an optimized mass flow error term, Φcᵢ. The optimized mass flow error parameter, Φ_{c}_{ᵢ}, can then be used to determine a corrected mass flow based on the measured mass flow as follows:

$${\dot{m}}_{l i {q}_{i}} ≡ \frac{{\dot{m}}_{m e a s}}{1 - {Φ}_{{c}_{i}}} \qquad ( Equation 34 )$$

More, or fewer, parameters and combinations of parameters can be used as correlation input parameters in the formulation of the correlation for the mass flow error parameter, Φcᵢ without departing from the methodology disclosed herein.

An aspect of the novelty of this embodiment is utilizing a density error parameter as a correlation input parameter in an optimized Coriolis correction correlation for the mass flow error parameter, along with parameters determined based on a measured process fluid sound speed, and other measured parameters and diagnostic parameters from Coriolis meters.

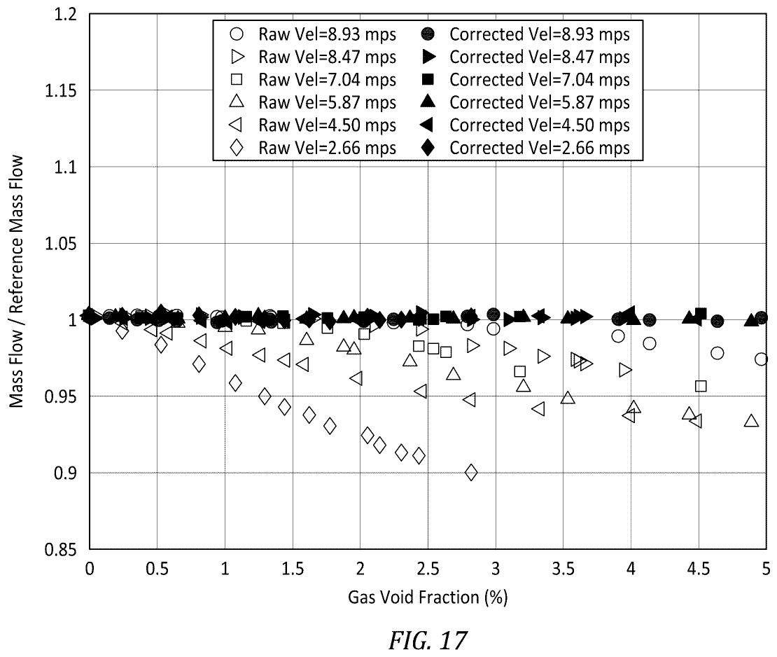

Referring now to FIG. 17, there is shown the normalized measured mass flow and normalized corrected mass flow utilizing the methodology described herein above for Coriolis Meter A with the optimized correlation weighting parameters listed in Table 1. For brevity and clarity, only the results for Coriolis meter A are shown in the FIG. 17, however, the results from Coriolis Meter B are similar and listed within this disclosure. The root mean square of the error in raw and corrected mass flow was reduced from 3.49% to 0.14% for Coriolis meter A and 1.74% to 0.28% for Coriolis meter B. The optimized correlation weighting parameters for mass error correlation for Coriolis meters A and B are set forth in Table 3 below.

TABLE 3

| Meter | A | B | C | D | E | F | G | H | I | J | K |
|---|---|---|---|---|---|---|---|---|---|---|---|
| A | 2.11 | −2.49 | 0.054 | −7.87 | −1.37 | 80.4 | 0.0023 | 0.017 | −0.08 | −0.54 | −2.29 |
| B | 0.168 | −0.44 | 0.378 | 25.65 | −28.7 | 24.40 | 0.0045 | 0.0323 | −0.07 | −0.83 | −1.66 |

Another implementation of the methodology of the current disclosure is illustrated below in which the density error parameter, the excitation energy, the vibration amplitude and the reduced pressure are used as correlation input parameters in a linear regression. This type of formulation is useful when the liquid density is known or determined and speed of sound measurements are not available.

$${⌊ {Ψ}_{i} {p}_{r e {d}_{i}} ( \frac{{EE}_{i}}{{AMP}_{i}} ) {Ψ}_{i}^{2} {{p}_{r e {d}_{i}^{2}} ( \frac{{EE}_{i}}{{AMP}_{i}} )}^{2} ( {Ψ}_{i} {p}_{r e {d}_{i}} ) ( {Ψ}_{i} \frac{{EE}_{i}}{{AMP}_{i}} ) ( {p}_{r e {d}_{i}} \frac{{EE}_{i}}{{AMP}_{i}} ) ⌋}_{NXM} {\{ \begin{matrix}A \\ B \\ C \\ D \\ E \\ F \\ G \\ H \\ I\end{matrix} \}}_{MX 1} = {⌊ {Φ}_{i} ⌋}_{NX 1} \qquad ( Equation 35 )$$

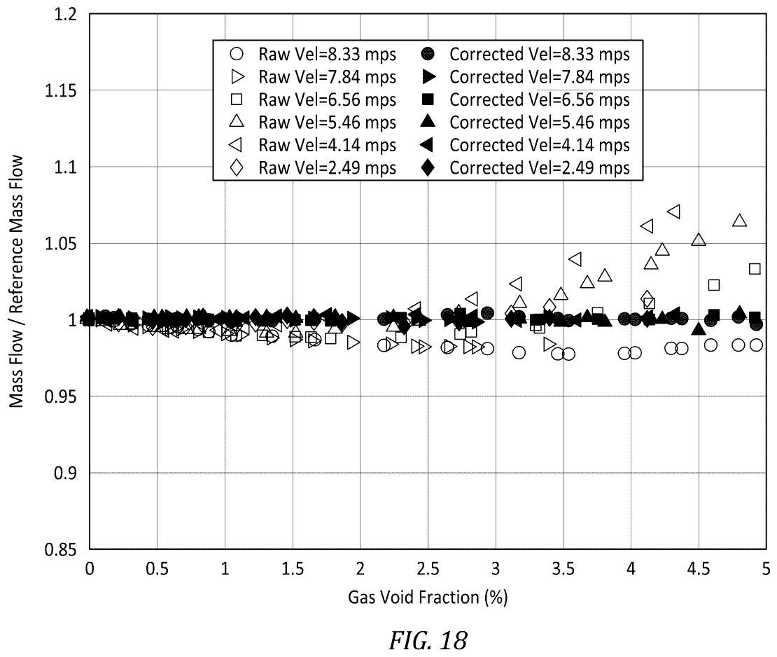

Referring to FIG. 18 there is shown a graphical representation of the normalized measured and normalized corrected mass flow utilizing the methodology described here in for Coriolis meter B with the optimized correlation weighting parameters listed in Table 4. For brevity and clarity, only the results from Coriolis Meter B are presented in FIG. 18, however the results for the method applied to Coriolis Meter A were similar in character and results from each meter are disclosed herein. The root mean square of the error in raw and corrected mass flow was reduced from 3.49% to 0.17% for Coriolis meter A and 1.74% to 0.15% for Coriolis meter B.

TABLE 4

| Meter | A | B | C | D | E | F | G | H | I |
|---|---|---|---|---|---|---|---|---|---|
| A | 1.93 | −1.92 | −1.24 | −16.9 | 15.1 | 84.2 | 0.008 | −.0001 | −.185 |
| B | 0.0214 | .507 | −.391 | 8.39 | −12.8 | 21.2 | 0.0099 | 0.0002 | −.197 |

Another implementation of the current disclosure uses the following correlation input parameters: 1) a density error function based at least in part on a measured density and an estimate of the density of the liquid phase of process fluid; 2) measured parameters based at least in part on a measured process fluid sound speed; 3) excitation energy diagnostics; and 4) vibrational amplitude diagnostics as input to a neural net formulation to minimize errors in reported mass flow of Coriolis meters operating on bubbly liquids.

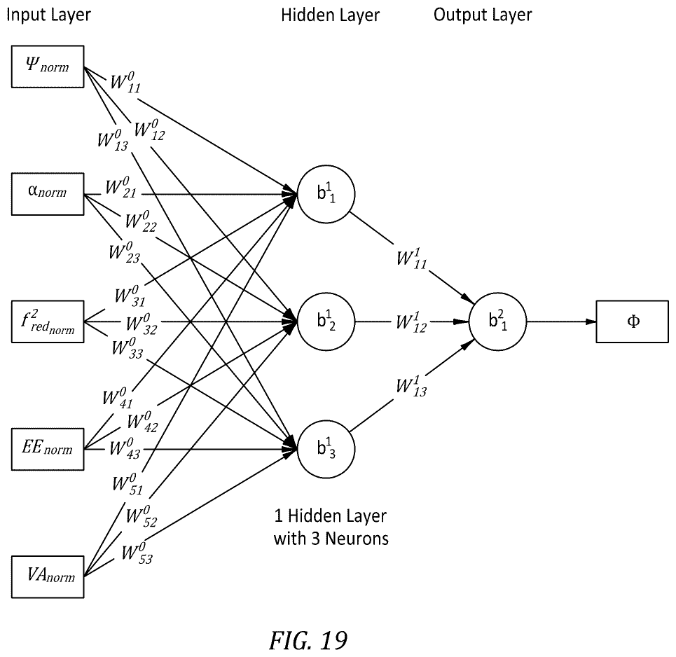

FIG. 19 shows a schematic of a neural network as an example of a preferred embodiment of the current invention. The neural network utilizes five normalized inputs, based on 1) the density error function, Ψ, 2) the gas void fraction, α, 3) the reduced frequency squared,

$${f}_{red}^{2} ,$$

4) the excitation energy agnostic, EE, and 5) the vibrational amplitude diagnostic, VA as correlation input parameters to a neural network with a single hidden layer with 3 neurons and an output layer consisting of a single neuron.

The inputs are normalized as follows using Ψ as an example:

$${Ψ}_{norm} = Ψ - min ( Ψ ) / ( max ( Ψ ) - min ( Ψ ) ) \qquad ( Equation 36 )$$

In this formulation, the weighted inputs to each neuron are summed and the bias is added to this sum. This result is then used as input to an activation function to produce the output of the neuron. The activation function for the hidden layer is a hyperbolic tangent function, and the activation function for the output layer is linear.

For example, the outputs of 3 neurons in the hidden layer are given by:

$$\{ \begin{matrix}{a}_{1}^{1} \\ {a}_{2}^{1} \\ {a}_{3}^{1}\end{matrix} \} = tan h ( ⌊ {W}_{i j}^{0} ⌋ \{ \begin{matrix}{Ψ}_{norm} \\ {α}_{n o r m} \\ {f}_{r e {d}_{n o r m}}^{2} \\ {EE}_{n o r m} \\ {AV}_{norm}\end{matrix} \} + \{ \begin{matrix}{b}_{1}^{1} \\ {b}_{2}^{1} \\ {b}_{3}^{1}\end{matrix} \} ) \qquad ( Equation 37 )$$

And the output of the network is the correlation of the mass flow error parameter associated with the correlation input parameters and is given by:

$$\{ {a}_{1}^{2} \} = ( ⌊ {W}_{i j}^{1} ⌋ \{ \begin{matrix}{a}_{1}^{1} \\ {a}_{2}^{1} \\ {a}_{3}^{1}\end{matrix} \} + \{ {b}_{1}^{2} \} ) = {Φ}_{correlation} \qquad ( Equation 38 )$$

A neural network as described above was trained utilizing reference data sets for each of the Coriolis meters. 70% of the data point in each reference data set were randomly selected for the training set used in an optimization process to determine optimized weighting and bias parameters for each data set.

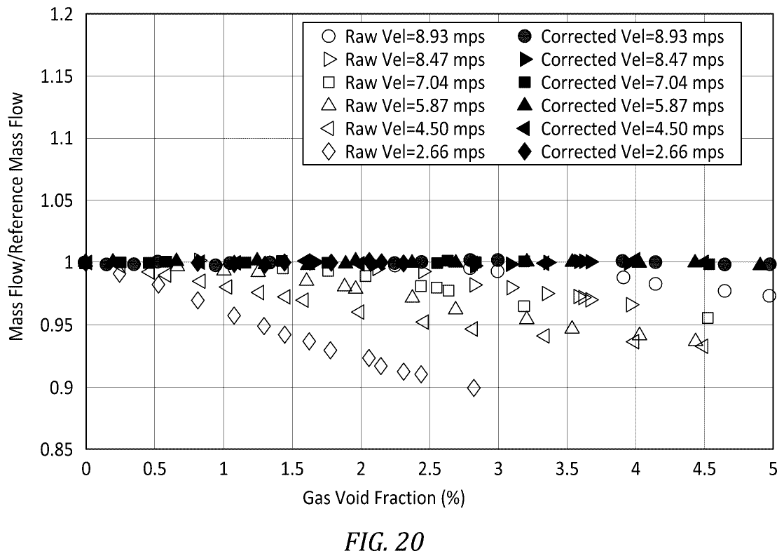

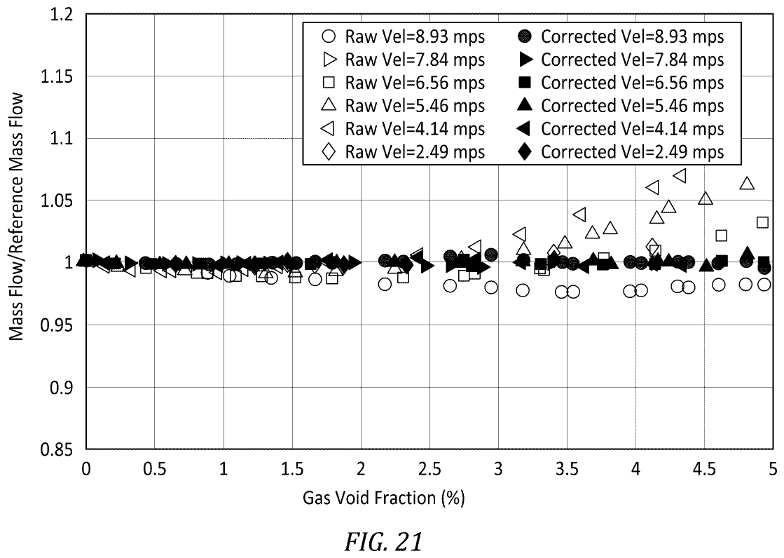

Referring next to FIGS. 20, 21, there is shown the normalized measured mass flow and a normalized corrected mass flow determined by applying the trained networks to the input parameters. As shown, the trained, single layer, 3-neuron, neural network which utilized the density error parameter, the gas void fraction, the reduced frequency squared, the excitation energy metric, and the vibrational amplitude diagnostic provides and effective means to reduce the error in mass flow each Coriolis meter operating on bubbly liquids. For Coriolis meter A, the root mean square of the error in the mass flow error parameter was reduced from 3.49% to 0.10%, and for Coriolis meter B, the root mean square of the error in the mass flow error parameter was reduced from 1.74% to 0.18%.

For Coriolis meter A the optimized correlation weighting parameters are given by:

$${W}_{ij}^{1} = ⌊ \begin{matrix}0.6615 & 0.2645 & - 0.8384 & 0.0617 & 0.0193 \\ - 0.6659 & 1.4653 & - 0.2143 & - 0.4099 & - 0.1918 \\ 1.066 & 0.4788 & - 0.0725 & - 0.3336 & - 0.1511\end{matrix} ⌋$$

$${W}_{i , j}^{2} = \{ \begin{matrix}- 0.8085 & - 1.1562 & 1.0108\end{matrix} \}$$

$${b}_{j}^{1} = \{ \begin{matrix}0.9479 \\ 0.638 \\ 0.8968\end{matrix} \} {b}_{j}^{2} = \{ 0.4995 \}$$

And for Coriolis Meter B, the optimized correlation weighting parameters are given by:

$${W}_{ij}^{1} = ⌊ \begin{matrix}0.9737 & - 0.8223 & - 1.2434 & 0.2752 & 0.5264 \\ 0.3651 & - 0.5939 & 0.9034 & - 0.45849 & - 0.8726 \\ 0.6112 & 0.2484 & - 0.819 & - 0.1864 & 1.40031\end{matrix} ⌋$$

$${W}_{i , j}^{2} = \{ \begin{matrix}0.23 29 & - 3.0001 & - 2.8153\end{matrix} \}$$

$${b}_{j}^{1} = \{ \begin{matrix}- 0.8031 \\ - 0.5304 \\ 2.052\end{matrix} \} {b}_{j}^{2} = \{ 0.6509 \}$$

It has been discovered that while including speed of sound based variables such as gas void fraction and the reduced frequency as correlation input parameters for the mass flow error parameter will typically improve the accuracy of the corrected mass flow of bubbly fluid. However, correlations which do not utilize speed of sound based variables as correlation input parameters can still provide significant improvements in the accuracy of the corrected mass flow. These correlations are particularly useful for applications for which a speed of sound measurement is not available.

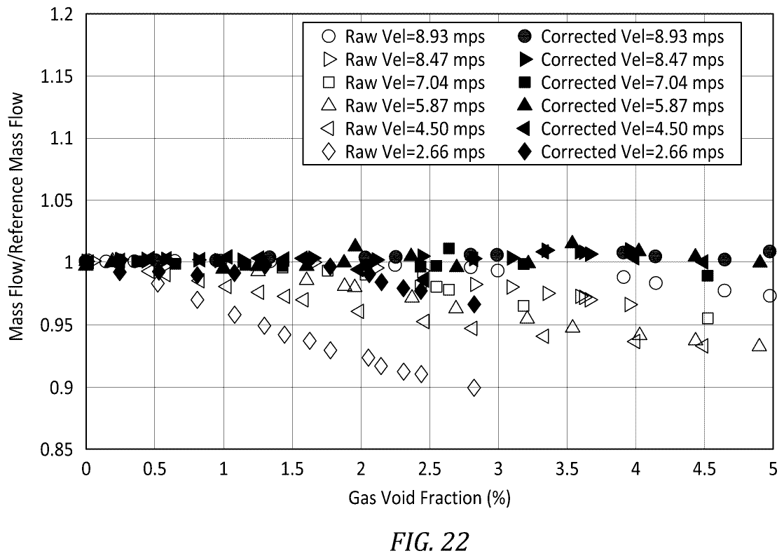

Referring to FIG. 22, there is shown the normalized measured mass flow and the normalized corrected mass flow where the corrected mass flow is based on the output of a 3 neurons, single hidden level, neural net. The neural net utilizes three correlation input parameters: the density error parameter, the excitation energy diagnostic, and 1 minus the vibration amplitude (1-VA). This network was trained with the same procedure as described for the previous neural network. As shown, the error in the mass flow error function was reduced from 3.49% rms to 0.72% rms for Coriolis Meter A, and from 1.74% rms to 0.51% rms for Coriolis Meter B.

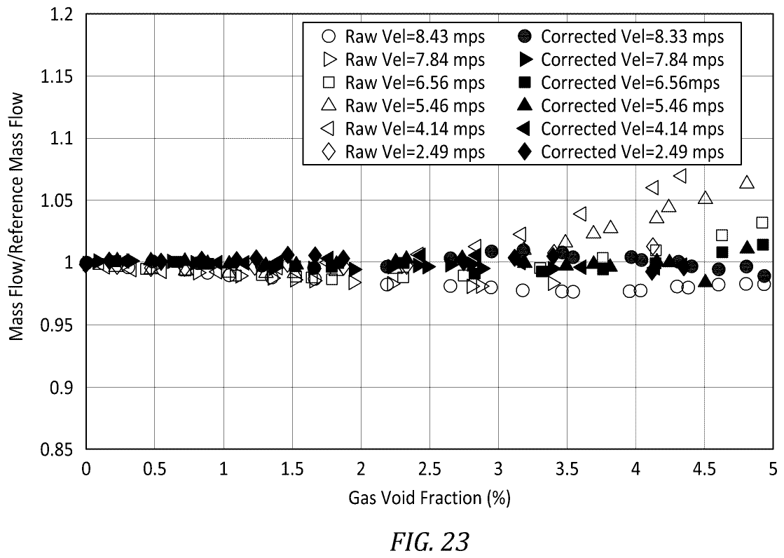

In another implementation of the current disclosure, the mass flow can be corrected utilizing correlations that do not utilize the density error parameter. This approach would be useful for Coriolis meters for which an accurate density measurement is not available, or the liquid density is not readily determined. Referring to FIG. 23, there is shown a graphical representation of the measured normalized mass flow and the corrected normalized mass flow predicted by a 3 neuron, single hidden level, neural net utilizing four correlation input parameters: 1) gas void fraction, 2) the reduced frequency squared, 3) the excitation energy diagnostic, and 4) 1 minus the vibration amplitude (1-VA). This neural network was trained with the same procedure as described for the previous neural network. As shown, the error in the mass flow error function was reduced from 3.49% rms to 0.61% rms for Coriolis Meter A, and from 1.74% rms to 0.41% rms for Coriolis Meter B.

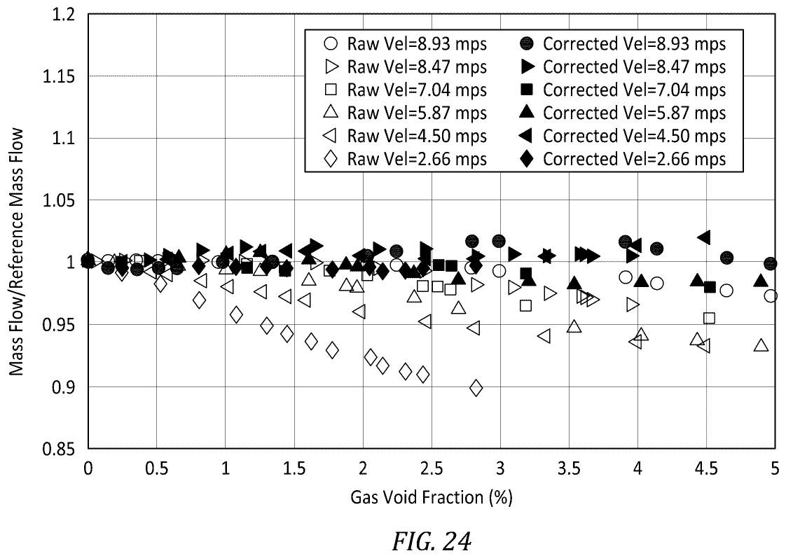

In yet another implementation of the current disclosure, the mass flow can be corrected utilizing a correlation that does not utilize the density error parameter or the excitation energy metric or the vibration amplitude metric. This approach would be useful for Coriolis meters for which an accurate density measurement is not available, or the liquid density is not readily determined and the diagnostics from the Coriolis meter are not available. Referring to FIG. 24, it shows the normalized measured mass flow and normalized corrected mass flow predicted by a 3 neuron, single hidden level, neural net utilizing two correlation input parameters: 1) gas void fraction, and 2) the reduced frequency squared. This neural network was trained with the same procedure as described for the previous neural network. As shown, the error in the mass flow error function was reduced from 3.49% rms to 0.79% rms for Coriolis Meter A, and from 1.74% rms to 1.12% rms for Coriolis Meter B.

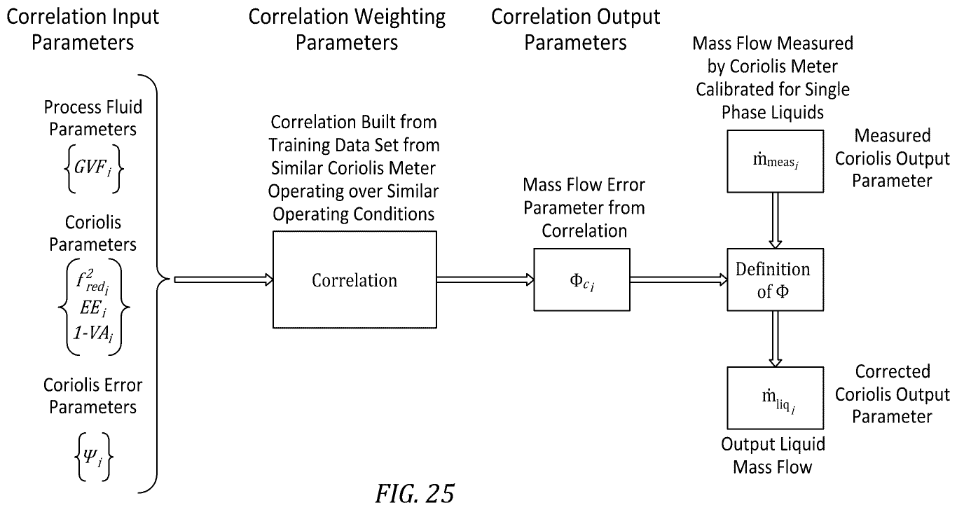

Referring to FIG. 25, there is shown a schematic of the approach disclosed herein above to determine a corrected mass flow.

Referring now to FIG. 26, there is shown a schematic of sound speed augmented Coriolis meter 70 suitable for use with methods disclosed herein. As shown, flow tubes 14 are exposed for illustrative purposes. Coriolis meter 70 includes inlet flange 71, outlet flange 72 and transmitter 73. Inlet flange 71 is configured to be coupled to an inlet pipe and outlet flange 72 is configured to be coupled to an outlet pipe. Transmitter 73 includes one or more processors, software and communication screens and ports. Also shown in the figure is centerline 74 drawn through the center of inlet flange 71 and outlet flange 72. In operation, process fluid enters Coriolis meter 70 though inlet flange 71, flows through a flow splitter, and is directed to flow tubes 14 and exits the Coriolis meter through outlet flange 72, after emerging from the flow tubes and being recombined by flowing effectively in reverse through a symmetric flow splitter. It should be appreciated by those skilled in the art that the ability to provide a process fluid speed of sound measurement utilizing only two pressure transducers near the inlet and outlet of a Coriolis meter provides a framework for cost-effective means to implement speed of sound augmented Coriolis meters. It should be further noted that sound speed augmented Coriolis meter 70 provides a measurement of the sound speed of the process fluid mixture as it flows through flow tubes 14. Other prior methods and apparatus either provide an estimate of the sound speed (or gas void fraction) or a measurement outside of the flow tubes 114 of the Coriolis meter.

Referring next to FIG. 27, there is shown a cross section of sound speed augmented Coriolis meter 80 from a cutline taken along centerline 74 (FIG. 26). It is known that dual tube Coriolis meters typically have flow splitters 83, 84 immediately upstream and downstream of the flow tubes. Sound speed augmented Coriolis meter 80 includes inlet flange 71, outlet flange 72, an inlet flow region 81 and an outlet flow region 72. Inlet flow region 81 comprises an inlet throat and defines a region within the Coriolis meter and includes inlet splitter 83 positioned upstream of flow tubes 14 for flow 89 to be is “split” into the two flow tubes 14. Outlet region 82 comprises an outlet throat defines a region within the Coriolis meter having an outlet region cross sectional area and includes outlet splitter 84 positioned downstream of flow tubes 14 to transition flow 89 from the flow tubes into the outlet flange 72 into a unitary flow steam and into an outlet pipe. The flow splitter region is typically contained within a dual tube Coriolis meter 11. Sound speed augmented Coriolis meter 80 includes an inlet throat pressure port 85 that penetrates the wall of the Coriolis meter near inlet flange 71 to access the flow area and further includes pressure transducer 86 positioned in fluid communication with the pressure port and configured to provide an acoustic pressure signal associated with process fluid 89 within the inlet splitter region 81. Similarly, sound speed augmented Coriolis meter 80 can include an outlet throat pressure port 87 that penetrates the wall of the Coriolis meter near outlet flange 72 to access the flow area and further includes pressure transducer 88 positioned in fluid communication with the pressure port and configured to provide an acoustic pressure signal associated with process fluid 89 within the outlet splitter region 82. In operation, pressure transducers 86, 88 are configured to produce signals indicative of the unsteady acoustic pressures of process fluid 89. As disclosed herein above, flow tubes 14 are of sufficient length such that beamforming algorithms can provide the ability to determine the speed of the process fluid flow 89 as it travels through sound speed augmented Coriolis meter 80 utilizing passive listening techniques. In such a configuration, transducers 86, 88 comprise an array. Other implementations include measuring the process fluid speed of sound utilizing the output of two pressure transducers inboard of the flanges of a Coriolis meter or on the flanges 71, 72. Adding pressure transducers either outboard of the flow splitters 83, 84, or inboard of the flow splitters, or on one of the flow tubes 14 near its mounting points are all methods of the present disclosure to obtain an acoustic pressure measurement without modifying the actively vibrating section of the Coriolis flow tubes. It is within the scope of the present disclosure that the two pressure transducers can also be installed within an inlet pipe and an outlet pipe in fluid communication with the Coriolis meter to retrofit an existing Coriolis meter to incorporate a process fluid speed of sound measurement.

It is noted that additional pressure sensors could be added to the array of two pressure sensors that span the flow tubes of the Coriolis meter to increase the aperture of the array of pressure sensor use to determine a process fluid sound speed to include more of the piping network upstream and downstream of the Coriolis meter without departing from the scope of this invention. Increasing the aperture of the array to improves the ability of this approach the provide a process fluid sound speed measurement under certain conditions. Increasing the number of sensors and increased aperture typically improves the ability the ability of passive listening techniques to accurately interpret the speed at which propagating signals propagate through an array of sensors provided the propagation characteristics of the process fluid remain essentially constant within the aperture of the array. Thus adding additional sensors as described above will in general improve the ability to determine a process fluid sound speed measurement in which applications for which the process fluid in the additional piping network included in the expanded aperture has a similar acoustic properties (e.g. pressure and gas void fraction) as the process fluid within the flow tubes of the Coriolis meter.

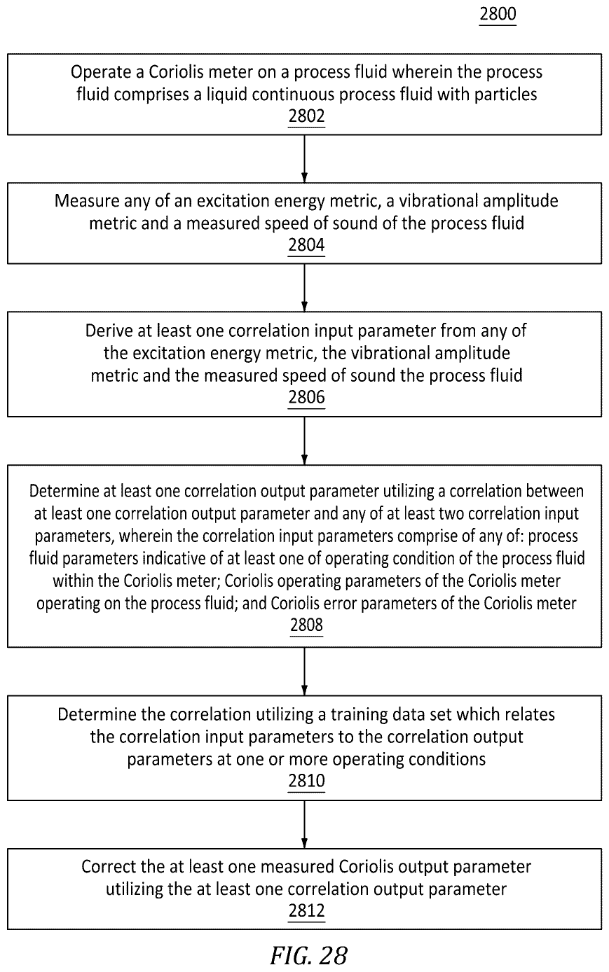

Referring to FIG. 28 there is shown a flowchart of an example process 2800. In some implementations, one or more process blocks of FIG. 28 may be performed by a Coriolis meter. As shown in FIG. 28, process 2800 may include operating the Coriolis meter on a process fluid where the process fluid may include a liquid continuous process fluid with particles (block 2802). As also shown in FIG. 28, process 2800 may include measuring any of an excitation energy metric, a vibrational amplitude metric and a measured speed of sound of the process fluid (block 2804). As further shown in FIG. 28, process 2800 may include deriving at least one correlation input parameter from any of the excitation energy metric, the vibrational amplitude metric and the measured speed of sound the process fluid (block 2806). As also shown in FIG. 28, process 2800 may include determining at least one correlation output parameter utilizing an optimized Coriolis correction correlation between at least one correlation output parameter and any of at least two correlation input parameters, where the correlation input parameters may include of any of: process fluid parameters indicative of at least one of operating condition of the process fluid within the Coriolis meter; Coriolis operating parameters of the Coriolis meter operating on the process fluid; and Coriolis error parameters of the Coriolis meter (block 2808). As further shown in FIG. 28, process 2800 may include where the optimized Coriolis correction correlation is determined utilizing a training data set which relates the correlation input parameters to the correlation output parameters at one or more operating conditions (block 2810). As also shown in FIG. 28, process 2800 may include correcting the at least one measured Coriolis output parameter utilizing the at least one correlation output parameter (block 2812).

Although FIG. 28 shows example blocks of process 2800, in some implementations, process 2800 may include additional blocks, fewer blocks, different blocks, or differently arranged blocks than those depicted in FIG. 28. Additionally, or alternatively, two or more of the blocks of process 2800 may be performed in parallel.

All of the methods disclosed and claimed herein can be made and executed without undue experimentation in light of the present disclosure. While the apparatus and methods of this disclosure have been described in terms of preferred embodiments, it will be apparent to those of skill in the art that variations may be applied to the methods and in the steps or in the sequence of steps of the method described herein without departing from the concept, spirit and scope of the disclosure. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Although the invention(s) is/are described herein with reference to specific embodiments, various modifications and changes can be made without departing from the scope of the present disclosure, as presently set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms scatter, diffuse and spread are among the same terms that similar meaning as delivering total available therapy light to a broader area than that of prior art methods. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

While the foregoing is directed to embodiments of the present disclosure, other and further embodiments of the disclosure may be devised without departing from the basic scope thereof, and the scope thereof is determined by the claims that follow.

### REFERENCES

[1] Wang T. and Baker, R., “Coriolis Flow Meters: A review of the developments over the past 20 years, and an assessment of the state of the art and likely future directions”, Journal of Flow Measurement and Instrumentation 40 (2014) pp 99-123.
[2] Weinstein, Joel, “Multiphase Flow in Coriolis Mass Flow Meters-Error Sources and Best Practices”, 28th International North Sea Flow Measurement Workshop 26-29 Oct. 2010.
[3] Hemp, J., and Kutin, J. “Theory of errors in Coriolis flowmeter readings due to compressibility of the fluid being metered”, Journal of Flow Measurement and Instrumentation, Volume 17, Issue 6, December 2006, Pages 359-369.
[4] Gysling, D, “An Aeroelastic model of Coriolis mass and density meters operating on aerated mixtures” Journal of Flow Measurement and Instrumentation, Volume 18, Issue 2, April 2007, Pages 69-77.
[5] Weinstein, Joel, “The Motion of Bubbles and Particles in Oscillating Liquids with Applications to Multiphase Flow in Coriolis Meters”, PHD Thesis, Department of Mechanical Engineering, University of Colorado, 2008.
[6] Zhu, Hao, Application of Coriolis Mass Flowmeters in Bubbly or Particulate Two-Phase Flows, PhD. Thesis, Institute of Fluid Mechanics, University of Erlangen-Nuremberg, Shaker Verlag, 2009.
[7] Basse, N. T., “A review of the theory of Coriolis flowmeter measurement errors due to entrained particles”, Journal of Flow Measurement and Instrumentation, Volume 37, June 2014, Pages 107-118.
[8] Wood AB. “A Textbook of Sound”, 3rd ed. London, UK: G. Bell & Sons; 1955.
[9] Temkin, S., “Sound Propagation in Bubbly Liquids” Naval Research Laboratory Memorandum Report 6403, 5 Apr. 1989.
[10] Fu, K. “Direct Numerical Study of Speed of Sound in Dispersed Air-Water Two-Phase Flow”, Wave Motion, Vol 98, November 2020.
[11] Gysling, D., Dragnea, G., “Density-based Watercut using a Speed-of-Sound Augmented Coriolis Meter on a Gas/Liquid Separator with Variable Gas Carry-Under”, 38th International North Sea Flow Measurement Workshop, 26-29 Oct. 2020.
[12] Gysling, D., “Accurate Coriolis Mass Flow and Density Measurement of Bubbly Fluids”, 40th Global Flow Measurement Workshop, 25-27 Oct. 2022.
[13] Johnson, Don, and Dudgeon, Dan, “Array Signal Processing-Concepts and Techniques”, ISBN 0-13-048513-6, Prentice-Hall, 1993.
[14] Basse, N. T., “Coriolis flowmeter damping for two-phase flow due to decoupling” Journal of Flow Measurement and Instrumentation”, Volume 52, December 2016, Pages 40-52.
[15] Deep Learning Toolbox, The Mathworks, Natick, M A.
[16] Ibryaeva, O., et al, A Benchmark Data Set for Two-Phase Coriolis Metering, Journal of Flow Measurement and Instrumentation 72:101721, March 2020
[17] Wang, Lijuan, et al., Gas-Liquid Two-Phase Flow Measurement Using Coriolis Flowmeters Incorporating Artificial Neural Network, Support Vector Machine, and Genetic Programming Algorithms IEEE TRANSACTIONS ON INSTRUMENTATION AND MEASUREMENT, VOL. 66, NO. 5, May 2017

What is claimed is:

1. A method for correcting at least one measured Coriolis output parameter of a Coriolis meter comprising:
operating the Coriolis meter on a process fluid wherein the process fluid comprises a liquid continuous process fluid with particles;
measuring a measured speed of sound of the process fluid;
deriving a first correlation input parameter from the measured speed of sound the process fluid;
determining at least one correlation output parameter utilizing an optimized Coriolis correction correlation between the correlation output parameter and the first correlation input parameter and at least a second correlation input parameter, wherein the at least second correlation input parameter comprises of any of:
a process fluid parameter indicative of at least one of operating condition of the process fluid within the Coriolis meter;
a Coriolis operating parameter indicative of the Coriolis meter operating on the process fluid; and
a Coriolis error parameter of the Coriolis meter;
wherein the optimized Coriolis correction correlation is determined utilizing a training data set which relates the correlation input parameters to the correlation output parameters at a plurality of operating conditions; and
correcting the at least one measured Coriolis output parameter utilizing the at least one correlation output parameter.

2. The method of claim 1 wherein the optimized Coriolis correction correlation is further determined by optimizing a plurality of correlation weighting parameters configured to minimize a difference between a predicted correlation output parameter and a correlation output parameter contained within or derived from the training data set.

3. The method of claim 1 wherein the at least a second correlation input parameter is derived from any of an excitation energy metric and a vibrational amplitude metric.

4. The method of claim 1 wherein the at least at least a second correlation input parameter comprises any of a mass flow, a density and a volumetric flow of the Coriolis meter.

5. The method of claim 1 wherein the particles comprise gas bubbles.

6. The method of claim 1 wherein the at least a second correlation input parameter comprises a parameter derived at least in part from measure speed of sound of the process fluid.

7. The method of claim 1 wherein the at least a second correlation input parameter is a density error parameter.

8. The method of claim 1 further comprising utilizing an array of acoustic pressure transducers that spans at least one flow tube of the Coriolis meter.

9. The method of claim 1 wherein the optimized Coriolis correction correlation comprises a neural network.

10. The method of claim 1 wherein the optimized Coriolis correction correlation comprises a least squares correlation.

11. A system for correcting at least one measured Coriolis output parameter of a Coriolis meter comprising:
one or more processors configured to:
operate the Coriolis meter on a process fluid wherein the process fluid comprises a liquid continuous process fluid with particles;
measure a measured speed of sound of the process fluid;
derive a first correlation input parameter from the measured speed of sound the process fluid;
determine at least one correlation output parameter utilizing an optimized Coriolis correction correlation between the correlation output parameter and the first correlation input parameter and at least a second correlation input parameter, wherein the at least second correlation input parameter comprises of any of:
a process fluid parameter indicative of at least one of operate condition of the process fluid within the Coriolis meter
a Coriolis operate parameter indicative of the Coriolis meter operating on the process fluid; and
a Coriolis error parameter of the Coriolis meter;
wherein the optimized Coriolis correction correlation is determined utilize a training data set which relates the correlation input parameters to the correlation output parameters at a plurality of operating conditions; and
correct the at least one measured Coriolis output parameter utilizing the at least one correlation output parameter.

12. The system of claim 11, wherein the optimized Coriolis correction correlation is further determined by optimizing a plurality of correlation weighting parameters configured to minimize a difference between a predicted correlation output parameter and a correlation output parameter contained within or derived from the training data set.

13. The system of claim 11, wherein the at least a second correlation input parameter is derived from any of an excitation energy metric and a vibrational amplitude metric.

14. The system of claim 11, wherein the at least at least a second correlation input parameter comprises any of a mass flow, a density and a volumetric flow of the Coriolis meter.

15. The system of claim 11, wherein the particles comprise gas bubbles.

16. The system of claim 11, wherein the at least a second correlation input parameter comprises a parameter derived at least in part from the measured speed of sound of the process fluid.

17. The system of claim 11, wherein the at least a second correlation input parameter is a density error parameter.

18. The system of claim 11, further comprising utilizing an array of acoustic pressure transducers that spans at least one flow tube of the Coriolis meter.

19. The system of claim 11, wherein the optimized Coriolis correction correlation comprises a neural network.

20. The system of claim 11, wherein the optimized Coriolis correction correlation comprises a least squares correlation.

21. A Coriolis meter comprising:
one or more processors configured to:
operate the Coriolis meter on a process fluid wherein the process fluid comprises a liquid continuous process fluid with particles;
measure a measured speed of sound of the process fluid;
derive a first correlation input parameter from the measured speed of sound the process fluid;
determine at least one correlation output parameter utilizing an optimized Coriolis correction correlation between the correlation output parameter and the first correlation input parameter and at least a second correlation input parameter, wherein the at least second correlation input parameter comprises of any of:
a process fluid parameter indicative of at least one of operate condition of the process fluid within the Coriolis meter
a Coriolis operate parameter indicative of the Coriolis meter operating on the process fluid; and
a Coriolis error parameter of the Coriolis meter;
wherein the optimized Coriolis correction correlation is determined utilize a training data set which relates the correlation input parameters to the correlation output parameters at a plurality of operating conditions; and
correct at least one measured Coriolis output parameter utilizing the at least one correlation output parameter.

22. The Coriolis meter of claim 21, wherein the optimized Coriolis correction correlation is further determined by optimizing a plurality of correlation weighting parameters configured to minimize a difference between a predicted correlation output parameter and a correlation output parameter contained within or derived from the training data set.

23. The Coriolis meter of claim 21, wherein the at least a second correlation input parameter is derived from any of an excitation energy metric and a vibrational amplitude metric.

24. The Coriolis meter of claim 21, wherein the at least at least a second correlation input parameter comprises any of a mass flow, a density and a volumetric flow of the Coriolis meter.

25. The Coriolis meter of claim 21, wherein the particles comprise gas bubbles.

26. The Coriolis meter of claim 21, wherein the at least a second correlation input parameter comprises a parameter derived at least in part from the measured speed of sound of the process fluid.

27. The Coriolis meter of claim 21, wherein the at least a second correlation input parameter is a density error parameter.

28. The Coriolis meter of claim 21, further comprising utilizing an array of acoustic pressure transducers that spans at least one flow tube of the Coriolis meter.

29. The Coriolis meter of claim 21, wherein the optimized Coriolis correction correlation comprises a neural network.

30. The Coriolis meter of claim 21, wherein the optimized Coriolis correction correlation comprises a least squares correlation.
